(19) United States
(12) Patent Application Publication
(10) Pub. No.: US 2009/0169772 A1
(43) Pub. Date: Jul. 2, 2009

(54) RETARDATION FILM, METHOD FOR PRODUCING RETARDATION FILM, POLARIZING PLATE AND LIQUID CRYSTAL DISPLAY

(75) Inventors: Rumiko Yamada, Tokyo (JP); Toshiaki Shibue, Tokyo (JP); Nobuo Kubo, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA OPTO, INC., hachioji-shi (JP)

(21) Appl. No.: 12/095,806

(22) PCT Filed: Nov. 22, 2006
(86) PCT No.: PCT/JP2006/323300

§ 371 Date: Jun. 2, 2008

(30) Foreign Application Priority Data
Dec. 9, 2005 (JP) 2005-356179

(51) Int. Cl. C09K 19/02; B29C 47/88; C08B 1/00; C08G 63/00; C08G 64/00

(52) U.S. Cl. 428/1.1; 264/210.1; 264/210.6; 536/56; 528/271; 536/69; 536/68

(57) ABSTRACT

Disclosed are a retardation film, a method for producing the retardation film, a polarizing plate comprising the retardation film, and a liquid crystal display comprising the polarizing plate. Specifically disclosed is a method for producing a retardation film, which comprises an extrusion step for extruding a composition containing a thermoplastic resin and having a temperature of To [° C.] from a die; a cooling step for cooling a film extruded from the die and having a glass transition temperature of Tg [° C.] to a temperature Ta [° C.]; a heating step for heating the cooled film to a temperature Tb [° C.] at least once; and a stretching step for cooling the heated film to a temperature Tc [° C.] and then stretching the cooled film in the width direction.

### TECHNICAL FIELD

The present invention relates to a retardation film, a method of producing retardation film, a polarizing plate and a liquid crystal display, in detail, to a retardation film improved in the light leaking and the dimensional stability under high temperature and high humidity conditions and effective for raising the front-view contrast of liquid crystal display, a method for producing the retardation film, a polarizing plate and a liquid crystal display.

### BACKGROUND ART

Liquid crystal display is widely used as the displaying device of liquid crystal TV and personal computer since which can be driven at low voltage and low electric consumption and directly connected IC circuits and particularly the display can be made thinner. In the basic constitution of the liquid crystal display, polarizing plates are arranged on both sides of a liquid crystal cell, for example.

There have been developed liquid crystal displays using twisted nematic liquid crystals (TN) with a twist angle of 90° and those using super twisted nematic liquid crystals (STN) with a twist angle of 160° or more hitherto. Recently, liquid crystal displays using vertical alignment liquid crystal, hereinafter referred to as VA, described in Tokkai Hei 2-176625, for example, are developed. The VA type liquid crystal display utilizing the vertical orientation mode is characterized in that black color is clearly reproduced, and the contrast of image is high and the viewing angle is wider than that of the TN or STN type displays.

However, a demand to further expanding the viewing angle is raised accompanied with the large sizing of the displaying face of liquid crystal display such as that of large sized TV and the retardation film becomes to be used for expanding the viewing angle. Consequently, the width of the retardation film is increasingly made wider accompanied with the enlargement of the displaying face of liquid crystal display.

For such the purpose, utilization of polymer film has been investigated. However, usual TAC film shows certain retardation value (Rt) in the thickness direction by extremely small retardation value (Ro) in the in-plane direction. Therefore, such the film is not always suitable for the purpose to improve the view angle of the VA type LCD, for example.

It is known for overcoming such the problem that a film can be obtained by stretching cellulose ester film in the width direction on the occasion of film formation, which is superior in the uniformity of retardation value and usable as the polymer film having a slow axis in the transverse direction and the protection film of polarizing plate.

However, it is known that a large retardation film causes remarkable lowering in the contrast due to the discrepancy of slow axis in the in-plane direction. Therefore, technologies noting the discrepancy in the slow axis are disclosed for keeping the displaying properties; cf. Patent Publications 1 and 2, for example.

Moreover, a concrete method for inhibiting the discrepancy of the slow axis of the in-plane of film is disclosed, in which the ununiformity of stretching in the bulk roll of the film is inhibited by softening the film by controlling the temperature of the film; cf. Patent Publication 3, for example.

A tenter stretching method is disclosed, in which the web is stretched by first tenter equipment and the width of the web is constantly held and then the web is stretched in the width direction by second tenter equipment: cf. Patent Publication 4, for example.

Furthermore, it is disclosed that a stretched film composed of thermoplastic norbornene type resin without occasion of bowing which has a uniform physical properties in the width direction and a little ununiformity in the thickness and retardation can be obtained by a tenter stretching method comprising a first process for preheating the film while clipping at a fixed intervals, a second process for gradually increasing the clipping interval to stretching the film in the width direction, and a third process for further increasing gradually the clipping interval to stretch the film in the width direction; cf. Patent Publication 5, for example.

However, it is the present situation that problems of contrast, dimensional stability under a high temperature and high humidity condition and light leaking as to the retardation film for large size display highly demanded recently, are required to be solved.

Patent Publication 1: Tokkai Hei 11-160536

Patent Publication 2: Tokkai 2002-22943

Patent Publication 3: Tokkai 2001-215332

Patent Publication 4: Tokkai 2002-311245

Patent Publication 5: Tokkai 2005-254812

### DISCLOSURE OF THE INVENTION

An object of the invention is to provide a retardation film, a method of producing the retardation film and a liquid crystal display which are improved in the light leaking and the dimensional stability under high temperature and high humidity conditions and raised in the front-view contrast.

The above objects can be attained by the following constitution.

1. A method of producing a retardation film, comprising:

an extruding step of extruding a composition comprising a thermoplastic resin and having a temperature To (° C.) through a die;

a cooling step of cooling a film having a glass transition temperature Tg (° C.) and extruded through the die, to a temperature Ta (° C.);

a heating step of at least once raising a temperature of the film which is cooled, to a temperature Tb (° C.); and

a stretching step of cooling the film which is heated, to a temperature Tc (° C.) and stretching the film which is cooled in a width direction of the film,

wherein the temperature Ta satisfies Ta<To and Ta<(Tg+10) ° C.,

the temperature Tb satisfies Tb>Ta and Tg≦Tb≦(Tg+70) ° C., and

the temperature Tc satisfies Tc<Tb and (Tg−20)° C.<Tc≧(Tg+50)° C.

2. The method of producing a retardation film described in the above Item 1, wherein the composition comprises a plasticizer or an antioxidant.

3. The method of producing a retardation film described in the above Item 1 or 2, wherein the film is held at the temperature of at the temperature Tb (° C.) in the heating step for not less than 1 second and not larger than 300 seconds.

4. The method of producing a retardation film described in any one of the above Items 1 to 3, wherein the thermoplastic resin is selected form the group consisting of a cellulose type resin, a cycloolefin type resin, a polycarbonate type resin, a polyester type resin and a polylactic acid type resin.

5. The method for producing a retardation film described in the above Item 4, wherein a major component of the cellulose type resin is a cellulose ester which is at least one selected from the group consisting of cellulose acetate, cellulose propionate, cellulose butylate, cellulose acetate propionate, cellulose acetate butylate, cellulose acetate phthalate and cellulose phthalate.

6. The method of producing a retardation film described in any one of the above Items 1 to 5, wherein the temperature To (° C.) satisfies (Tg+50) ° C.≦To≦(Tg+140) ° C.

7. The method of producing a retardation film described in any one of the above Items 1 to 6, wherein the temperature Tb (° C.) satisfies Tb>Ta and Tg≦Tb≦(Tg+55) ° C.

8. A retardation film produced by the method of producing a retardation film described in any one of the above Items 1 to 7.

9. The retardation film described in the above Item 8,

wherein the retardation film comprises a slow axis in a width direction of the film, an in-plane retardation value Ro is in a range of 30 to 100 nm, a retardation value Rt in a thickness direction of the film is in a range of 70 to 300 nm, and a ratio of Rt/Ro is from 2 to 5.

Where,

Ro=(nx−ny)×d,

Rt={(nx+ny)/2−nz}×d,

nx is an in-plane refractive index in a slow axis direction of the film, ny is an in-plane refractive index in a fast axis direction of the film, nz is a refractive index in the thickness direction of the film and d is the thickness of the film in nanometer.

10. A polarizing plate comprising: a polarizing element and the retardation film described in the above Item 5 or 9 pasted on at least one surface of the polarizing element.

11. A liquid crystal display comprising the polarizing plate described in the above Item 10.

### BRIEF DESCRIPTION OF THE DRAWINGS

FIG. 1 shows a summary flow sheet of an embodiment of an apparatus for carrying out the method of producing the retardation film relating to the invention.

FIGS. 2(a) to 2(d) show schematic drawings of heating equipment.

FIGS. 3(a) to 3(d) show schematic drawings of thermal hysteresis of the film.

FIG. 4 shows schematic drawing of an example of tenter stretching equipment (12) preferably usable in an embodiment of the invention.

### THE BEST MODE FOR CARRYING OUT THE INVENTION

In this description, the term of “contrast” means “front-view contrast” unless specific description is not attached.

An object of the invention is to raise the front-view contrast. The front-view contrast is the contrast of the whole display and is not contrast at a local portion of a part of the display. For example, contrast lowering at the four corners and contrast lowering in frame like shape caused by light leaking are observed. These are the problems that are locally caused phenomena and different in the means from the front-view contrast to be raised in an embodiment of the invention.

The raising of the front-view contrast in the present description can be attained by inhibiting the cause of the light leaking but the above dynamically or locally contrast lowering tend to be able to inhibited by controlling the photoelasticity and is quite different from the embodiment of the invention in the mechanism thereof.

The best mode for carrying out the invention is described in detail below but the invention is not limited to the description.

The retardation film relating to the invention can be obtained by the method of producing a retardation film of the invention comprising: an extruding step of extruding a composition comprising a thermoplastic resin and having a temperature To (° C.) through a die; a cooling step of cooling a film having a glass transition temperature Tg (° C.) and extruded through the die, to a temperature Ta (° C.); a heating step of at least once raising a temperature of the film which is cooled, to a temperature Tb (° C.); and a stretching step of cooling the film which is heated, to a temperature of Tc (° C.) and stretching the film which is cooled in a width direction of the film, wherein the temperature Ta satisfies Ta<To and Ta<(Tg+10) ° C., the temperature Tb satisfies Tb>Ta and Tg≦Tb≦(Tg+70) ° C., and the temperature Tc satisfies Tc<Tb and (Tg−20) ° C.≦Tc≦(Tg+50) ° C.

The glass transition temperature of the retardation film relating to the invention can be determined as follows; an endothermic curve of the film is prepared by heating 10 mg of the film sample from −40° C. to 200° C. at a heating rate of 20° C./minute by using a DSC apparatus DSC220, manufactured by Seiko Instrument Inc., and straight lines each tangent to before and after portion of the inflection point of the endothermic curve are drawn and the crossing point of the lines is defined as the glass transition temperature (Tg).

As a result of investigation by the inventor, it is found that there can be provided the following process in a stretching method of a retardation film in order to reduce the light leaking from whole display when displaying a black screen and to enhance the front-view contrast: a film obtained by extruding a composition including a thermoplastic resin at the temperature To (° C.) through a die, is cooled to the temperature Ta (° C.), then, is heated at least once to the temperature Tb (° C.), and is cooled to the temperature To (° C.) to be stretched in a width direction of the film. Thereby, the molecules of the thermoplastic resin forming the film can be rapidly oriented in the stretched direction, and it controls the occurrence of fine crystals (or crystallization) of the polymer itself or the additives and the phase separation of the additive from the polymer, which results in inhibiting the unnecessary light leaking.

For producing the retardation film relating to the invention, the retardation film is preferably produced under the following conditions but the conditions are not limited to the followings.

### (Producing Method of the Retardation Film Relating to the Invention)

The production method of the retardation film relating to the invention is described in detail below.

### (Film Formation)

For producing the retardation film, also referred as to optical film, relating to the invention, a mixture of the thermoplastic film and an additive is dried by hot air or in vacuum and melted at a temperature of from 200 to 280° C., preferably from 200 to 260° C. and filtered, and then extruded into film shape through a T-die for contacting with a cooling drum by a method such as a static electricity applying method and solidified by cooling to obtain an unstretched film. The temperature of the cooling drum is not more than (Tg+10) ° C. and preferably maintained at a temperature of from 90 to 150° C.; in the above Tg is the glass transition temperature of the film.

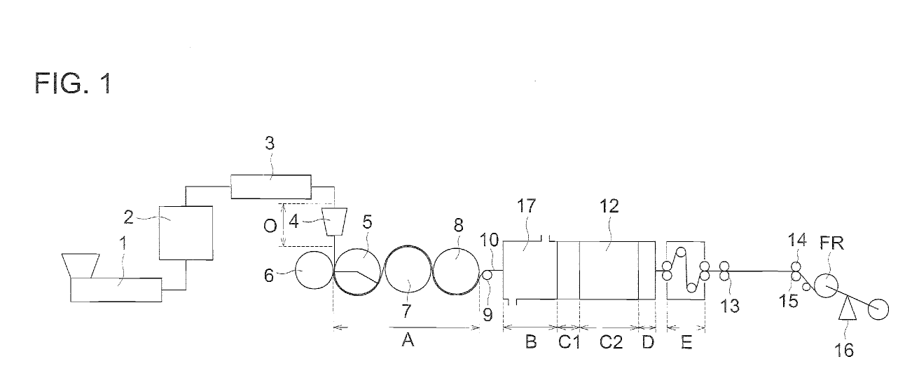

FIG. 1 shows a schematic flow sheet of equipment for carrying out the retardation film production method relating to the invention.

In the retardation film production method relating to the invention shown in FIG. 1, the materials of the film such as the thermoplastic resin, for example cellulose type resin, are mixed and extruded by the use of an extruder 1 onto a cooling roller or a cooling drum through a die 4 (Extrusion Step O) for touching with the out side of a first cooling roller 5 while pressing the film to the surface of the first cooling roller 5 by a touching roller 6, and the film is further successively touched to a second cooling roller 7 and a third cooling roller 8, three rollers in total for cooling and solidifying to prepare a unstretched film (Cooling Step A). The unstretched film 10 peeled from the cooling roller by a peeling roller 9 is raised in the temperature by a designated value in a heating apparatus 17 (Heating Step B), and the film is cooled again (Temperature Controlling C1). Then the film is stretched in the width direction while being held at the both side edges (Stretching Step C2) and winded up by a winder 16. An alleviation step D or a thermal treating step E may be inserted between the stretching and the winding as show in FIG. 1.

In the retardation film production method relating to the invention, the materials are preferably dried previously. The drying is preferably carried out by a vacuum or reduced pressure drying machine or a dehumidifying hot air drying machine to make the moisture content to not more than 1,000 ppm, preferably not more than 200 ppm.

It is preferable that the thermoplastic resin and the additives are previously mixed by a mixing machine, and the additives such as a plasticizer, a UV absorbent and a matting agent can be previously mixed by a mixing machine before melting. As the mixing machine, usual mixers such as a V-type mixer, a cone screw type mixer, a horizontal cylinder type mixer are applicable.

For instance, the thermoplastic resin dried by hot air or under vacuum is melted at an extruding temperature about 200 to 280° C. by the extruder 1 and filtered by a filter such as a leaf disk type filter 2 for eliminating foreign matters.

When the materials are introduced into the extruder 1 from a supplying hopper, not shown in the drawing, it is preferable to avoid contacting with moisture or oxygen for preventing oxidation decomposition by carrying out the introducing under vacuum, reduced pressure or in inactive gas atmosphere.

When any additive such as plasticizer is not previously added, the additive may be kneaded-in on the way to the extruder. A mixing device such as a static mixer 3 is preferably used for uniformly adding.

In an embodiment of the invention, it is possible that the materials are once made in a form of pellets and then melted by the extruder 1 to form the film other than the method by which the materials are directly formed into the film after mixing. Furthermore, it is possible in a system of mixture of plural materials with different melting points from each other that a half-melted composition in which melted material and non-melted material are mixed is once prepared at a temperature at which the material having lower melting point is only melted and then the half-melted composition is charged into the extruder for forming the film. When using the resin or additive each easily decomposed by heat, the method of directly forming the film without preparation of pellets and the method of forming the film after preparation of the half-melted composition are preferable.

In the embodiment of the invention, the extruder 1 used for forming the film, may be a mono-axial extruder or a biaxial extruder. When the film is directly formed from the materials without preparation of the pellets, suitable kneading is necessary. Therefore, the biaxial extruder is preferably used; however, suitable kneading state can be obtained by changing the shape of the screw to a kneading type screw such as Maddock type, unimelt type and dalmage so that the film can be formed even when the mono-axial extruder is used. It is desirable to provide a vent for removing gas through the vent using a pump as to both of the mono-axial or the biaxial extruder. When the pellets or the half-melted composition is used, the mono-axial and biaxial extruders are usable.

The melting temperature of the resin in the extruder 1 is preferably within the range of from (Tg+50) ° C. to (Tg+140)° C., though the melting temperature is varied depending on the viscosity and the extruding amount of the resin and the thickness of the film to be produced. The melting temperature is more preferably within the range of from (Tg+50) ° C. to (Tg+110) ° C. The viscosity of the melted composition on the occasion of the extrusion is preferably from 10 to 100,000 poises and preferably from 100 to 10,000 poises. The staying time of the resin in the extruder is preferably as short as possible and not more than 5 minutes, more preferably not more than 3 minutes and most preferably not more than 2 minutes. The staying time is varied depending on the kind of extruder and the extrusion conditions, but the staying time can be shortened by controlling the supplying amount of the materials, L/D, rotation rate of the screw and the deepness of the groove.

The shape and rotation rate of the screw are suitably selected according to the viscosity and extruding amount of the resin. In the embodiment of the invention, the sharing rate of the film in the extruder 1 is preferably from 1 (/sec) to 10,000 (/sec), more preferably from 5 (/sec) to 1,000 (/sec) and most preferably from 10 (/sec) to 100 (/sec). A pre-filter is preferably provided on the exit side of the extruder to prevent biting in the pump and reduce the load on the main filter.

For instance, a screen of 50/80/100 mesh or a metal fiber sinter filter is preferably provided according to necessity. As the screen and the sinter filter, on-line changeable ones are preferably used.

It is preferable to stabilize the flowing amount by introducing a gear pump. Moreover, a filter 2 is preferably provided in the lower course of the pre-filter. As such the filter, a stainless steel fiber sinter filter is preferably applied. The stainless fiber sinter filter is a filter prepared by complexly entangling stainless steel fibers and sintering them at the touching points to unify, and the filtering accuracy of which can be controlled by varying the density according to the thickness and the depressing ratio of the stainless steel fibers. The stainless steel fiber sinter filter is preferably a multi-layered one composed of coarse and fine layers alternatively piled for plural times. A constitution in which the filtering accuracy is successively raised or a constitution in which high and low accuracy are repeated are preferable, the lifetime of the filter can be prolonged and the capturing accuracy to foreign matters and gel can be raised by such the filter The filtering accuracy is preferably from 0.5 to 50 μm.

In the melt-casting film forming method, line-shaped defects are sometimes caused when the die 4 has scratches or when foreign matters adhere at the knot of the die 4. Such the defects are called as die lines. For reducing surface defects such as the die-lines, it is preferable to make the structure of the equipment so that the portion where the resin is stayed in the course of from the extruder 1 to the die 4 is reduced as few as possible. Moreover, it is preferable to use the die reduced in the damage in the interior or on the lip as few as possible. The atmosphere containing a volatile ingredient is preferably sucked out because the volatile substance can be precipitated around the die 4 to cause die-lines Moreover, the volatile ingredient cam be precipitated on the apparatus such as the static electricity applying device; therefore, the precipitation is preferably prevented by applying alternative electric current or another means such as heating.

The die is not specifically limited as long as the die is one usable for producing a sheet or film, however, the die 4 is preferably a coat hunger die. The lip space t is preferably not less than 0.1 mm and not more than 2 mm and the length L of the land portion of the die is preferably not less than 5 mm and not more than 50 mm. L/t is preferably not less than 10.

The surface roughness of the inner wall of the piping is preferably low and the value of it is preferably not more than 0.3 S for preventing adhesion of the resin. The internal wall of the piping is preferably plated by the hard chromium and subjected to buff polishing. Moreover, it is preferable to use the die reduced in the damage in the interior or on the lip as few as possible. The atmosphere containing volatile ingredient is preferably sucked out because a volatile substance can be precipitated around the die 4 to cause die-lines. Moreover, the volatile ingredient can be precipitated on the apparatus such as the static electricity applying device; therefore, the precipitation is preferably prevented by applying alternative electric current or another means such as heating.

The die is not specifically limited as long as the die is one usable for producing a sheet or film, but the die 4 is preferably a coat hunger die. The lip space t is preferably not less than 0.1 mm and not more than 2 mm and the length L of the land portion of the die is preferably not less than 5 mm and not more than 50 mm. L/t is preferably not less than 10.

When the thickness of the resin just after contacting with the first cooling roller 5 is h, the value t/h is preferably not more than 10 when the thickness of the film is not less than 70 μm and not more than 100 μm. The value t/h is preferably not more than 15 when the thickness of the film is not less than 50 μm and not more than 70 μm. The value t/h is preferably not more than 20 μm when the thickness of the film is less than 50 μm. By defining the value t/h as described above, the expansion of melted liquid ribbon can be inhibited and the retardation in the flowing direction can be held at a low level.

In the producing method of retardation film relating to the invention, the radius R of the cross section of the corner of the lip of the film takeout side and the lip edge of the film anti-takeout side of the die 4 is preferably made not more than 100 μm, more preferably not more than 50 μm. Under such the condition, occurrence of adhesion of foreign matter can be prevented and the retardation can be made uniform, resulting in maintaining the flatness of the film in good condition.

As the film thickness controlling mechanism, there is preferably utilized a heater system in which the temperature of the film is separately controlled in the width direction, a hand controlling bolt system in which the opening degree of the lip is mechanically controlled, and a heat-bolt system in which the opening degree of the lip is controlled by utilizing expansion of the bolt by heating.

As the material of the die 4, one is cited which is sputtered or plated with nickel, hard chromium, chromium carbide, chromium nitride, titanium carbide, titanium carbide nitride, titanium nitride, super steel or ceramics such as tungsten carbide, aluminum oxide and chromium oxide, and treated with polishing by buff, lapping by a whetstone of #1000 or less, plane shaving by a diamond whetstone of #1000 or more in the direction vertical to the flowing direction of the resin, electrolytic polishing or electrolytic composite polishing.

The preferable material of the lip portion of die is the same as that of the die 4. It is important to reduce the friction between the lip and the resin for preventing occurrence of shark skin. For such the purpose, use of ceramic coating, (commercial: K05MFC) manufactured by Dual Spiral Systems Inc., is preferred. The surface roughness of the lip portion is preferably nor more than 0.5 S and more preferably not more than 0.2 S.

In the above embodiment of the invention, the materials extruded from the die 4 is cooled to a temperature of less than the temperature of the materials at the extrusion and less than (Tg+10)° C. by the cooling roller for correcting the surface of the film; in the above, Tg is the glass transition temperature of the film. When the cooling roller on which the materials extruded from the die 4 is firstly touched is referred to as the first cooling roller 5, the interval from the die 4 to the time of touching to the cooling roller 5 is preferably shorter and not more than 10 seconds, more preferably not more than 5 seconds, and most preferably not more than 2 seconds. The distance from the die 4 to the cooling roller 5 is preferably not less than 10 mm and not more than 100 mm. The retardation in the flowing direction caused by expansion of the melted liquid ribbon can be reduced by holding the temperature of the resin. A shorter interval between the touching of extruded material onto the cooling roller to the pressing is effective for correction of the die line and the material is preferably pressed within 0.5 seconds after touching to the roller. For such the purpose, it is necessary to firstly touch the material to the roller at a position as near as possible to the pressing position, and the extruded material is preferably touched at the position on the circumference of the roller within a center angle of not more than 10 to the pressing position. The distance in which the extruded material is touched to the roller until the pressing is applied is preferably from 2 to 100 mm. When the material is fallen between the two rollers, the pressure for pressing the film is made unstable and excellent film difficulty produced. The temperature of the resin is preferably held at the air gap between the exit of the die 4 and the position just before the position where the resin is touched to the cooling roller 5. As the temperature holding method, induction heating by microwaves and radiation heating by an infrared heater are preferably applicable. As the infrared heater, electric, gas, oil and steam far-infrared ceramic heater can be applied.

In the above embodiment, a suction device is preferably provided near the die 4 for preventing contamination of the die and the cooling roller caused by sublimated material on the occasion of extrusion of the resin from the die 4. A countermeasure such as heating the suction device by a heater is necessary for preventing adherence of the sublimated material onto the suction device itself. When the sucking pressure is excessively high, the quality of the film is lowered by occurrence of stepwise uniformity, and is too low, the sublimation material is not effectively sucked; therefore, the application of suitable pressure is necessary.

In the above embodiment, the film and the cooling roller is preferably closely contacted. For closely contacting the film to the cooling roller, a static electrical contacting method, an air knife and a reduce pressure chamber can be applied.

The number of the cooling roller may be one or more and the use of two or more of the cooling rollers is preferable for raising the flatness of both sides of the film and the both sides of the film are preferably contacted with the cooling rollers Cleaning equipment such as a cleaning roller can be provided to the cooling rollers. The unevenness in the temperature and the speed of the cooling roller are each preferably not more than 0.5° C. and not more than 0.5%, respectively. Chromium plating may be applied on the surface of the cooling roller but the treatment is not limited to that. The surface roughness is preferably not more than 0.1 s. As the material of the touching roller, metal and a metal roller covered with resin or rubber are usable. A crown roller in which the diameter is varied from the central portion in the width direction to the both ends can also be used.

The temperature control of the cooling roller (or cooling drum) is preferably carried out by flowing of a thermal medium such as water and oil in the cooling roller (or cooling drum).

In the embodiment of the invention, the melted thermoplastic resin is extruded from the T-die 4 into a film shape and successively contacted with the first cooling roller 5, the second cooling roller 5 and the third cooling roller to solidify by cooling while transferring to obtain a unstretched film 10. The cooled and solidified unstretched film 10 is peeled from the third cooling roller 8 by the peeling roller 9 and introduced into the stretching machine 12, where the film 10 is stretched in the width direction. The molecules in the film are oriented by the stretching.

The embodiment of the invention is characterized in that the unstretched film 10 having a glass transition temperature Tg is at least once heated to a temperature not less than (Tg)° C. and not higher than (Tg+70)° C. and higher than the cooling temperature and the stretching temperature between the peeling roller 9 and the stretching machine 12. The phrase of “heating to the above temperature range” in this description means that the temperature of the film itself is held within the above range by exposing the film to the atmosphere having a temperature within the above range. Consequently, it is preferable that the temperature of the film itself is reached at a temperature within the above range and the time for holding the temperature at such the range is preferably not less than 1 second and not more than 300 seconds. It is more preferable that the film having the glass transition temperature Tg is held within the range of from (Tg+10) ° C. to (Tg+55) ° C. The temperature of the film itself can be determined by arranging at least one, preferably two or more, non-contacting type thermometers in the width direction and averaging the measured temperature data. It is preferable to feed hack the obtained temperature data to the following heating means for controlling the temperature raising.

The effects of the invention can be obtained by raising the temperature of the film to the glass transition temperature Tg or more at the portion between the peeling roller 9 and the stretching machine 12. The temperature of the film is preferably not more than (Tg+70)° C. because the effects of the invention can be obtained and the coloring of the film can be avoided. The effects of the invention can be sufficiently obtained when the time for holding the temperature is not less than 1 second and coloring, breaking and twisting of the film are difficultly caused when the time is not less than 300 seconds; therefore, such the temperature holding time is preferred The time for holding the film temperature can be controlled by the transferring speed of the film in the temperature raising process and the size or length of the temperature raising apparatus.

The effects of the invention can be obtained by one time of the temperature raising treatment though the treatment of one to three times is economical as the production process since coloring, breaking and twisting of the film are difficultly caused.

The means for raising the temperature of the film having the glass transition temperature of Tg by a temperature not less than (Tg) ° C. and not higher than (Tg+70)° C. and higher than the cooling temperature and the stretching temperature is not specifically limited and the heating can be carried out by hot air, infrared rays, heating roller or microwave. Hot air is preferable because of its simplicity and the plural means may be applied in combination. In FIG. 1, an example in which hot air is blown in the heating apparatus 17 is shown.

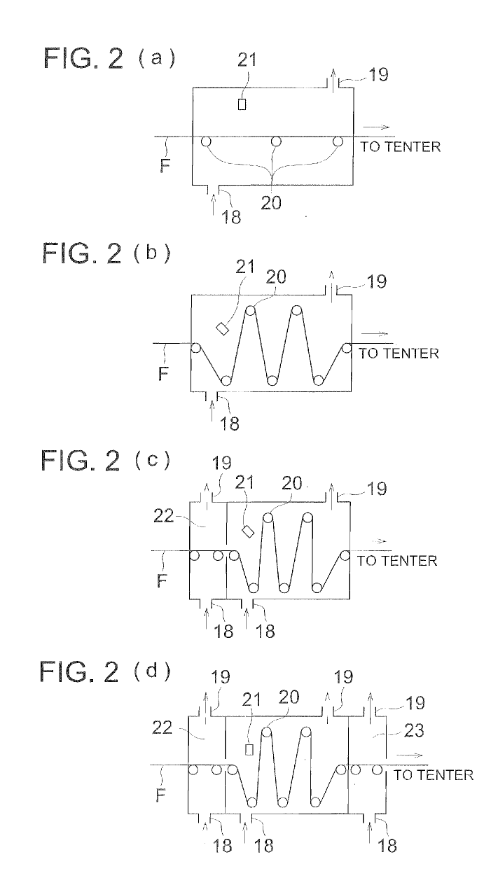

FIGS. 2(a) to 2(d) are each a schematic drawing of the heating apparatus 17. FIG. 2(a) shows the schematic drawing of a heating apparatus 17 in which hot air is blown through a hot air introducing vent 18 into the place where the film F is transferred by transfer roller 20 to heat the film to the designated temperature and is exhausted from an exhausting vent 19. The temperature of the film is measured by the non-contacting thermometer 21. In the schematic drawing of FIG. 2(b), the transfer roller 20 are arranged upper and bottom portions of the apparatus so that suitable tension can be applied to the film on the occasion of the heating. In the schematic drawing of FIG. 2(c), a pre-heating chamber 22 is provided so that the heating can be carried out by two steps. In the schematic drawing of FIG. 2(d), a heat alleviation chamber 23 is provided after the heating apparatus 17 additionally to the pre-heating chamber 22, the temperature of the film to be transferred into the tenter can be controlled with high precision by introducing air heated at suitable temperature through the air introducing vent 18 provided on the heat alleviation chamber. In the apparatus relating to the invention, the temperature raising is preferably carried out while holding the film at the both side edges by the tenter and tension in the transfer direction is preferably inhibited at a low level.

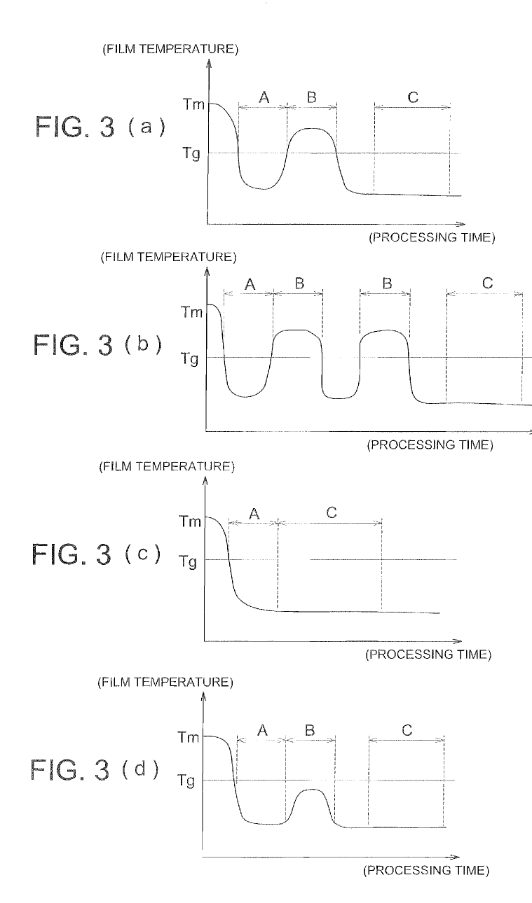

FIGS. 3(a) to 3(d) schematically show the temperature hysteresis of the film in step O to step C in FIG. 1. In the graphs, the vertical axis represents the temperature of the film and the horizontal axis represents the processing time, and the initial point of the graph shows the temperature of the film at step O. The symbols Tm and Tg on the vertical axis of the graphs are each represents the melting temperature and the glass transition temperature of the film, respectively.

The temperature hysteresis of the films of examples of the invention includes the case in which the temperature of the film is once raised by a temperature not less than (Tg) ° C. and not higher than (Tg+70) ° C. and higher than the cooling temperature and the stretching temperature as shown in FIG. 3(a) and the case in which the film temperature is raised twice to the above temperature as shown in FIG. 3(b). The hysteresis in which the film is held at the cooled temperature without any raising in the temperature as shown in FIG. 3(c) and the hysteresis in which the film is heated at a temperature of less than (Tg)° C. and not less than (Tg−20)° C. as shown in FIG. 3(d) are cited as the comparative examples. In FIGS. 3(a) to 3(d), the cooling step, the heating step and the stretching step in the tenter after cooling are each referred to as step A, step B and step C, respectively.

As the method for stretching the film in the width direction, usually known tenter can be preferably applied. The stretching in the width direction is preferable since the lamination with the polarization film can be carried out in the rolled state. The slow axis of the thermoplastic film is made width direction by the stretching in the width direction.

Besides, the transparent axis of the polarization film is also agreed with the width direction. The image contrast of the display can be raised and suitable view angle can be obtained by combining the polarizing plate into the display, in which the polarization film and the thermoplastic film are over layered so that the transparent axis of the former and the slow axis of the later are in parallel.

As the stretching conditions, temperature and stretching ratio, of the unstretched film 10 in the stretching machine 12 can be selected so that the desired retardation property is obtained. The stretching ratio is usually from 1.1 to 2.0 times and preferably from 1.2 to 1.5 times. The desired retardation property can be obtained when the stretching ratio is higher than the lower limit of the above range and the breaking of the film can be avoided when the stretching ratio is lower than the upper limit of the above range; therefore, the above range of the stretching ratio is preferred.

In examples of the invention, the film having a glass transition temperature Tg is heated to a temperature not less than (Tg) UC and not higher than (Tg+70)° C. and higher than the cooling temperature and the stretching temperature and then cooled to a temperature not less than (Tg−20)° C. and not higher than (Tg+50)° C. and stretched. The stretching carried out at a temperature of not more than (Tg+50)° C. and not less than 100° C. is effective.

The stretching in the width direction of the film is preferably carried out under uniform temperature distribution controlled in the width direction. The stretching may be performed under temperature condition having a little ununiformity and the ununiformity of the temperature is preferably within the range of ±2° C., more preferably ±1° C., and most preferably ±0.5° C.

The thermoplastic film prepared in the above method may be shrunk in the length or width direction for controlling the retardation property or reducing the dimensional variation ratio. For shrinking in the length direction, for instance, a method in which the film is relaxed in the length direction by temporarily releasing the clips and a method in which the spaces between the adjacent clips of the widthwise stretching machine are gradually reduced are applicable. The later method can be carried out by using a usual biaxial stretching machine in which the spaces between the adjacent clips are smoothly and gradually reduced by moving the clips by, for instance, a pantograph system or a linear driving system. The stretching may be combined with stretching in an optional (oblique) direction. The dimensional variation ratio of the retardation film can be reduced by shrinking the film in a ratio of from 0.5° to 10% in the length and width direction.

A tenter in which the holding length (the distance between the initiation of holding and the end of the holding) of right and left sides of the web can be independently controlled by the right and left clipping means of the tenter is preferably used.

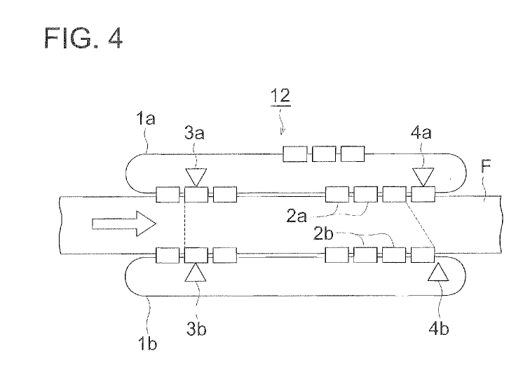

As the means for making different the holding distance on the right and left sides by independently controlling the holding length at the right and left sides of the web, for instance, one shown in FIG. 4 is applicable in concrete. FIG. 4 shows the schematic drawing of a tenter apparatus 12 which is preferably applied on the occasion of producing the thermoplastic resin film in the embodiment relating to the invention. In this drawing, the holding length of right side and that of left side of the film F are varied from each other by independently varying clip beginning position of the right and left clips 2a and 2b of the tenter apparatus 12, namely the setting positions of the clip closers 3a and 3b are each independently varied so that the clip beginning positions are different on the right and left sided from each other. By such the operation, force twisting the film is generated in the tenter 12 and aberration of the film position caused at a portion other than the tenter 12 can be corrected so that the occurrence of meanders, scars and wrinkles can be effectively prevented even when the transferring distance of from the peeling to the tenter is long.

In the tenter stretching apparatus 12 which is schematically drawn in the drawing, many clips 2a and 2b are usually arranged on a pair of endless chains (circled chains) 1a and 1b and the tracks of the chains are designed so that the clips 2a and 2b for holding and stretching the both edges of the film F which are positioned at the portion where the chain is proceeded to straight line of the progressing side are gradually drawn apart and film F is stretched in the width direction.

Moreover, in the embodiment of the invention, an apparatus for preventing the meanders for further highly precisely correcting the wrinkles, scars and distortion is preferably provided, and a meander preventing apparatus such as the edge position controller or the center position controller, sometimes each referred to as EPC and CPC, respectively, described in Tokkai Hei 6-8663 are preferably used. In such the apparatuses, the edge of the film is detected by an air servo sensor or a photo sensor and the transfer direction is controlled according to the signals from the sensor so that the position of the edge or the center of the width direction of the film is positioned at the designated position. As the actuator of such the apparatus, one or two guide rollers or a flat expander roller having a driver are moved in the right and left (or up and down) directions as to the line direction for correcting the meander or pairs of small pinch roller are each provided on both sides of the film (the pinch rollers are separately arrange on the surface side and the back side of the film, respectively, and such the pairs are each provided at the right and left side edges of the film) for nipping and pulling the film (cross guider system). The principal of the meandering correction of these apparatuses is as follows; for instance, when the film is going to move toward left side in the course of running, the roller is inclined so as to move the film toward to right side in the former system and the roller pair provided at the right side nips the film and pulls toward to right side in the latter system. It is preferable that at least one of such the meandering prevention apparatus is inserted between the film peeling point and the tenter stretching machine. A heat treatment apparatus for heating the film at a temperature not less than (Tg−30)° C. and less than (Tg)° C. is preferably applied after the treatment by the tenter process.

The web transfer tension in the thermal treatment process is preferably from 120 to 200 N/m, more preferably from 140 to 200 N/m, and most preferably from 140 to 110 N/m though the tension is influenced by the temperature in the thermal treatment process.

A tension cutting roller is preferably provided for preventing expansion of the film in the length direction.

The thermal treatment of the film is generally carried out by hot air, infrared rays, a heating roller or microwave without any limitation, and the hot air is preferable from the viewpoint of simplicity.

The thermal treatment in the thermal treatment process of the film having a glass transition temperature of Tg is effectively carried out at a temperature of not more than (Tg+50)° C. and not less than 100° C. for a time not less than 10 minutes and not more than 60 minutes. The thermal treatment is carried out at a temperature of from 100 to 200° C. and more preferably from 110 to 160° C.

The thickness of the retardation film to be used in the embodiment of the invention is from 30 to 200 μm in the finished state and the thickness of from 40 to 120 μm, particularly from 40 to 80 μm, is preferable for the recent thin type retardation film. The average thickness of the film can be controlled by controlling the extruding flow amount, the gap space of the die 4, and the rotating rate or the cooling roller so as to obtain the desired thickness.

The both edge portions are slit off by slitter 13 so as to make to the product width and the film is subjected to embossing treatment for forming embossment at both sides by an embossing device composed of an embossing roller 14 and a back roller 15 and winded up by a winder 16 for preventing adhesion and scratches in the bulk roll of the film FR. The embossing treatment can be carried out by pressing or heating by a ring having embossed patterns on the outer circumference thereof.

The clip holding portions at the both edges of the film cut off by the in the film forming process, which is called as returned material, may be reused as the material of the same or different kind of film after graining according to necessity. The returned material is preferably reused after washing by a solvent.

The retardation film having a multilayered structure can be produced by co-extruding compositions different from each other in the concentration of additives such as later-mentioned plasticizer, UV absorbent and matting agent. For instance, the retardation film having a constitution of (Skin layer)/(Core layer)/(Skin layer) can be prepared. For example, the matting agent can be added to the skin layer in larger amount or only in the skin layer. The plasticizer and the UV absorbent can be added to the core layer in a larger amount than that in the skin layer and only in the core layer. The kind of the plasticizer or UV absorbent in the core layer and the skin layer can be changed, for instance, a low volatile plasticizer and/or UV absorbent are added into the skin layer and a plasticizer excellent in the plasticizing ability or a UV absorbent excellent in the UV absorbing ability is added into the core layer. The skin layer and the core layer may be different in the glass transition temperature and the glass transition temperature of the core layer is preferably lower than that of the skin layer. The skin layer and the core layer may be different also in the viscosity on the occasion of the extrusion of the melted composition containing the cellulose ester, and the relation of it may be either (viscosity of skin layer)≧(viscosity of core layer) or (viscosity of core layer)≧(viscosity of skin layer).

As the preferable important matter of the retardation film relating to the invention, easiness of production, high adhesiveness with the polarization film and optical transparency are cited and the thermoplastic resin film containing the thermoplastic resin is preferred.

In this description, “transparent” means that the transmittance of visible rays through the film is not less than 60% and the transparency is preferably not less than 80%, and particularly preferably not less than 90%.

There is no limitation as to the thermoplastic resin unless the resin has the above described properties. A cellulose ester type resin, a polyester type resin, a polycarbonate type resin, a polyallylate type resin, a polysulfone type resin including polyethersulfone, a polyethylene type resin, a norbonene type resin, a cycloolefin type resin, an acryl type resin and a polylactic acid type resin can be exemplified though the resin is not limited to the above. The followings are preferable among them as the thermoplastic resin for a cellulose type resin for a retardation film relating to the invention: a cellulose ester type resin, a polycarbonate type resin, a cycloolefin type resin, a polyester type resin and a polylactic acid type resin. Specifically, the cellulose ester type resin is preferable as the thermoplastic resin from the view point of production, cost, transparency, uniformity and adhesiveness, in the embodiment of the invention.

Cellulose ester type resin film suitable for the thermoplastic film relating to the invention is described below.

### (Cellulose Ester Type Resin Film)

Cellulose ester to be used for the cellulose ester type resin film is a single or mixed acid ester of cellulose containing at least one of structures of an aliphatic acyl group and a substituted or unsubstituted aromatic acyl group.

Examples of the benzene ring substituent group when the aromatic ring in the aromatic acyl group is a benzene ring include, a halogen atom, a cyano group, an alkyl group, an alkoxy group, and aryl group, an aryloxy group, an acyl group, a carbonamide group, a sulfonamide group, a ureido group, an aralkyl group, a nitro group, an alkoxy carbonyl group, an aryloxy carbonyl group, an aralkyoxy carbonyl group, a carbamoyl group, a sulfamoyl group, an acyloxy group, an alkenyl group, an alkinyl group, an alkyl sulfonyl group, an aryl sulfonyl group, an alkyloxy sulfonyl group, an aryloxy sulfonyl group, an alkyl sulfonyloxy group, and an aryloxy sulfonyl group, —S—R, —NH—CO—OR, —PH—R, —P(—R)₂, —PH—O—R, —P(—R)(—O—R), —P(—O—R)₂, —PH(═O)—R—P(═O)(—R)₂, —PH(═O)—O—R, —P(═O)(—R) (—O—R), —P(═O) (—O—R)₂, —O—PH(═O)—R, —O—P(═O)(—R)₂—O—PH(═O)—O—R, —O—P(═O)(—R)(—O—R), —O—P(═O)(—O—R)₂, —NH—PH(═O)—R, —NH—P(═O)(—R)(—O—R), —NH—P(═O) (—O—R)₂, —SiH₂—R, —SiH(—R)₂, —Si(—R)₃, —O—SiH₂—R, —O—SiH(—R) 2 and —O—Si(—R)₃. R above is a fatty acid group, an aromatic group, or a heterocyclic group. The number of substituent groups is preferably between 1 and 5, more preferably between 1 and 4 and still more preferably between 1 and 3, and most preferably either 1 or 2. Examples of the substituent group preferably include a halogen atom, a cyano group, an alkyl group, an alkoxy group, an aryl group, an aryloxy group, an acyl group, a carbonamide group, a sulfonamide group, and a ureido group, and more preferably, a halogen atom, a cyano group, an alkyl group, an alkoxy group, an aryloxy group, an acyl group, and a carbonamide group, and still more preferably, a halogen atom, cyano, an alkyl group, an alkoxy group, and an aryloxy group, and most preferably, a halogen atom, an alkyl group, and an alkoxy group.

Examples of the halogen atom include a fluorine atom, a chlorine atom, a bromine atom, and an iodine atom The alkyl group may have ring structure or may be branched. The number of carbon atoms in the alkyl group is preferably 1-20, more preferably 1-12, still more preferably 1-6, and most preferably 1-4. Examples of the alkyl group include methyl, ethyl, propyl, isopropyl, butyl, t-butyl, hexyl, cyclohexyl, octyl and 2-ethyl hexyl. The alkoxy group may have ring structure or may be branched The number of carbon atoms in the alkoxy group is preferably 120, more preferably 1-12, still more preferably 1-6, and most preferably 1-4. The alkoxy group may be further substituted by another alkoxy group. Examples of the alkoxy group include a methoxy, ethoxy, 2-methoxyethoxy, 2-methoxy-2-ethoxyethoxy, butyloxy, hexyloxy and octyloxy.

The number of carbon atoms in the aryl group is preferably 6-20, and more preferably 6-12. Examples of the aryl group include phenyl and naphtyl. The number of carbon atoms in the aryloxy group is preferably 6-20, and more preferably 6-12. Examples of the aryloxy group include phenoxy and naphtoxy. The number of carbon atoms in the acyl group is preferably 1-20, and more preferably 1-12. Examples of the acyl group include hormyl, acetyl, and benzoyl. The number of carbon atoms in the carbonamide group is preferably 1-20, and more preferably 1-12. Examples of the carbonamide include acetoamide and benzamide The number of carbon atoms in the sulfonamide group is preferably 1-20, and more preferably 1-12. Examples of the sulfonamide include methane sulfonamide, benzene sulfonamide, and p-toluene sulfonamide. The number of carbon atoms in the ureido group is preferably 1-20, and more preferably 1-12. Examples of the ureido group include (unsubstituted) ureido.

The number of carbon atoms in the aralkyl group is preferably 7-20, and more preferably 7-12. Examples of the aralkyl group include benzyl, phenethyl, and naphtyl methyl. The number of carbon atoms in the alkoxycarbonyl group is preferably 1-20, and more preferably 2-12. Examples of the alkoxycarbonyl group include methoxy carbonyl. The number of carbon atoms in the aryloxy carbonyl group is preferably 7-20, and more preferably 7-12. Examples of the aryloxy carbonyl group include phenoxy carbonyl. The number of carbon atoms in the aralkyloxycarbonyl is preferably 8-20, and more preferably 8-12. Examples of the aralkyoxycarbonyl include benzyloxycarbonyl. The number of carbon atoms in the carbamoyl group is preferably 1-20, and more preferably 1-12. Examples of the carbamoyl group include (unsubstituted) carbamoyl and N-methyl carbamoyl. The number of carbon atoms in the sulfamoyl group is preferably no greater than 20, and more preferably no greater than 12. Examples of the sulfamoyl group include (unsubstituted) sulfamoyl and N-methyl sulfamoyl. The number of carbon atoms in the acyloxy group is preferably 1-20, and more preferably 2-12. Examples of the acyloxy group include acetoxy and benzoyloxy.

The number of carbon atoms in the alkenyl group is preferably 2-20, and more preferably 2-12. Examples of the alkenyl group include vinyl, aryl and isopropenyl. The number of carbon atoms in the alkinyl group is preferably 2-20, and more preferably 2-12. Examples of the alkinyl group include dienyl. The number of carbon atoms in the alkyl sulfonyl group is preferably 1-20, and more preferably 1-12. The number of carbon atoms in the aryl sulfonyl group is preferably 6-20, and more preferably 6-12. The number of carbon atoms in the alkyloxy sulfonyl group is preferably 1-20, and more preferably 1-12. The number of carbon atoms in the aryloxy sulfonyl group is preferably 6-20, and more preferably 6-12=The number of carbon atoms in the alkyl sulfonyloxy group is preferably 1-20, and more preferably 1-12. The number of carbon atoms in the aryloxy sulfonyl is preferably 6-20, and more preferably 6-12.

In the cellulose ester relating to the invention, in the case where the hydrogen atom of the hydroxyl group portion of the cellulose is a fatty acid ester with a fatty acid acyl group, the number of carbon atoms in the fatty acid acyl group is 2-20, and specific examples thereof include acetyl, propionyl, butyryl, isobutyryl, valeryl, pivaroyl, hexanoyl, octanoyl, lauroyl, stearoyl and the like.

The aliphatic acyl group in the present description also refers to one which is further substituted, and examples of the substituent include those which when the aromatic ring in the aromatic acyl group described above is a benzene ring, are denoted in the substituents of the benzene ring.

When the ester group of cellulose ester has an aromatic ring, the number of the substituent groups X on the aromatic ring should be 0 or 1-5, preferably 1-3, and 1 or 2 is particularly preferable. In addition, when the number of substituent groups substituted on the aromatic ring is 2 or more, the substituent groups may be the same or different from each other, and they may also bond with each other to form a condensed polycylic ring (such as naphthalene, indene, indane, phenanthrene, quinoline, isoquinoline, chromene, chromane, phthalazine, acridine, indole, indoline and the like).

In the embodiment of the invention, the cellulose ester has in the ester group a structure selected from at least one of a substituted or unsubstituted aliphatic acyl group or a substituted or unsubstituted aromatic acyl group, and this may be a single acid cellulose ester or a mixed acid cellulose ester, and two or more types of cellulose esters may be used in combination.

The cellulose ester used in the invention is preferably at least one type selected from cellulose acetate, cellulose propionate, cellulose butyrate, cellulose acetate propionate, cellulose acetate butyrate, cellulose acetate phthalate and cellulose phthalate.

The lower aliphatic acid esters such as cellulose acetate propionate and cellulose acetate butyrate, which are preferred as the mixed aliphatic acid cellulose ester, have an acyl group having 2 to 4 carbon atoms as the substituent.

In the invention, cellulose acetate propionate and cellulose acetate butyrate, which satisfy both Equation (1) and Equation (2) below, are preferred.

2.0≦X+Y≦3.0 Equation (1)

0≦X≦2.5 Equation (2)

wherein, X is a substitution degree of an acetyl group, Y is a substitution degree of an propionyl group or a butyryl group. Those satisfying the above-described 2 equations are suitable for manufacturing a retardation film which exhibits excellent optical property to meet an object of this invention.

Among them, triacetyl cellulose and cellulose acetate propionate are specifically preferably utilized. Tn cellulose acetate propionate, X is in 1.0≦X≦2.5, and it is preferable that Y and X+Y are 0.1≦Y≦1.5 and 2.0≦X+Y≦3.0. A substitution degree of an acyl group can be measured by a measurement method based on ASTM-D817-96.

When the aforesaid substitution degree of an acyl group is larger than the lower limit of the above range, the unreacted portion against hydroxyl groups of a pyranose ring constituting a skeleton of cellulose resin increases to make a small residual amount of said hydroxyl groups, resulting in enhance of ability to restrain variation of retardation depending on humidity and to protect a polarizing element as polarizing plate protective film, which is preferable.

The number average molecular weight of cellulose ester utilized in this invention is preferably in a range of 60,000-300,000 because of large mechanical strength of prepared film. Those having a number average molecular weight of 70,000-200,000 are more preferably utilized.

The number average molecular weight of cellulose ester can be measured as follows.

Measurement is performed by means of high speed liquid chromatography under the following condition.

Solvent: Acetone

Column: MPW×1 (produced by Toso Co., Ltd.)

Sample concentration: 0.2 (weight/volume)%

Flow rate: 1.0 ml/min

Sample injection quantity: 300 μl

Standard sample: standard polystyrene

Temperature 23° C.

Cellulose as a starting material of cellulose ester utilized in this embodiment is not specifically limited, and includes such as cotton linter, wood pulp and kenaf. Further, cellulose ester prepared from them can be utilized by mixing each of them at an arbitrary ratio.

Cellulose ester relating to this invention, in the case that an acylation agent as a cellulose starting material is acid anhydride (acetic anhydride, propionic anhydride, and butyric anhydride), is prepared by a reaction utilizing a proton type catalyst such as sulfuric acid in an organic acid such as acetic acid or in an organic solvent such as methylene chloride. In the case that an acylation agent is acid chloride (CH₃COCl, C₂H₅COcl, C₃H₇COCl), the reaction is performed utilizing a basic compound such as amine as a catalyst. Specifically, the synthesis can be performed referring to a method described in JP-A 10-54804.

An average substitution degree of an acyl group at the 6-position of a glucose unit of cellulose ester utilized in this invention is preferably 0.5-0.9.

A highly reactive primary hydroxyl group is present at the 6-position of a glucose unit constituting cellulose ester, different from the 2-position and the 3-position, and this primary hydroxyl group preferentially forms sulfuric ester in a manufacturing process of cellulose ester employing sulfuric acid as a catalyst. Therefore, in an esterification reaction of cellulose, the average substitution degree at the 2-position and the 3-position of a glucose unit can be made larger that that at the 6-position by increasing the amount of sulfuric acid as a catalyst, compared to general cellulose ester. Further, when necessary, since a hydroxyl group at the 6-position of a glucose unit can be selectively protected when cellulose is tritylated, it is possible to make the average substitution degree at 2-position and the 3-position of a glucose unit larger than that at the 6-position, by protecting a hydroxyl group at the 6-position by tritylation and releasing a trityl group (a protective group) after esterification. Specifically, cellulose ester manufactured by a method described in JP-A 2005-281645 can be also preferably utilized.

In the case of acetyl cellulose, it is necessary to prolong the time of an acetylation reaction to increase an acetylation degree. However, when the reaction time is excessively long, decomposition will proceed simultaneously to cause such as cut off of a polymer chain and decomposition of an acetyl group, which leads to an unfavorable result. Therefore, it is necessary to set the reaction time of a certain range to increase the acetylation degree and depress decomposition to some extent. To regulate by reaction time is not suitable because the reaction conditions are various to be changed depending on the reaction equipment and installation and other conditions. Since molecular weight distribution is broadened as decomposition of polymer proceeds, also in the case of cellulose ester, the degree of decomposition can be determined by a value of weight average molecular weight (Mw)/number average molecular weight (Mn), which is generally utilized. That is, in a process of acetylation of cellulose triacetate, a value of weight average molecular weight (Mw)/number average molecular weight (Mn) can be utilized as one index not to advance decomposition too much due to prolonged reaction time but to perform acetylation reaction for sufficient time.

An example of a manufacturing method of cellulose ester will be shown below. Cotton linter of 100 weight parts as a cellulose starting material was crushed, being added with 40 weight parts of acetic acid, and the resulting system was subjected to a pre-treatment activation at 36° C. for 20 minutes. Thereafter, the system was added with 8 weight parts of sulfuric acid, 260 weight parts of acetic acid anhydride and 350 weight parts of acetic acid, and the resulting system was subjected to esterification at 36° C. for 120 minutes. After neutralization with 11 weight parts of a 24% magnesium acetate aqueous solution, saponification reipnig at 63° C. for 35 minutes was performed to prepare acetyl cellulose. The product, after having been stirred for 160 minutes at room temperature by use of 10 times of an acetic acid aqueous solution (acetic acid/water=1/1 (weight ratio)), was filtered and dried to prepare purified acetyl cellulose having an acetyl substitution degree of 2.75. This acetyl cellulose had Mn of 92,000, Mw of 156,000 and Mw/Mn of 1.7. In a similar manner, by adjusting esterification conditions (temperature, time, stirring) and hydrolysis conditions, cellulose ester having a different substitution degree and a different Mw/Mn can be synthesized.

Herein, cellulose ester synthesized is preferably subjected to purification to remove a low molecular weight component and to filtration to remove a component which has not been acetylated or has a low acetylation degree.

Further, mixed acid cellulose ester can be prepared by a method described in Tokkai Hei 10-45804.

Further, cellulose ester is also affected by trace amounts of metal components in cellulose ester. These are considered to be related with water utilized in a manufacturing process, and a component which forms insoluble nuclei is preferably as small as possible in quantity; and metal ions of such as iron, calcium and magnesium, which may form an insoluble product by salt formation with such as polymer decomposition product possibly containing an organic acid group, are preferably small in quantity. An iron (Fe) component is preferably not more than 1 ppm. A calcium (Ca) component is easily form a coordination compound, that is a complex, with a acid component such as carboxylic acid and sulfonic acid as well as with many ligands, to form many insoluble scum (insoluble sediment, muddiness) derived from calcium.

A calcium (Ca) component is not more than 60 ppm and preferably 0-30 ppm. A magnesium (Mg) component is preferably 0-70 ppm and specifically preferably 0-20 ppm, since an excess amount thereof also generates an insoluble product. Metal components such as a content of iron (Fe), calcium (Ca) and magnesium (Mg) can be analyzed by use of an ICP-AES (an induction coupling plasma emission spectrophotometer) after completely dried cellulose ester is subjected to pretreatment by a micro-digest wet decomposition apparatus (sulfuric nitric acid decomposition) and alkali fusion.

### (Additive)

The retardation film relating to the invention preferably contains various kinds of plasticizer, an antioxidant such as hindered amine type or hindered amine type compounds, a phosphite ester type compounds, a phosphonite type compound, and a stabilizer. Especially, The retardation film preferably contains plasticizer or an antioxidant.

Moreover, a peroxide compound decomposing agent, a radical capturing agent, a metal deactivating agent, a UV absorbent, a matting agent, a dye, a pigment, and an antioxidant other than the hindered phenol type compound are preferably contained.

In the embodiment of the invention, the additives are used for inhibiting the formation of volatile composition caused by deterioration or decomposition of the material such as coloration and lowering in the molecular weight and not cleared decomposing reaction, for instance, preventing oxidation of the film constituting composition, capturing of acid formed by decomposition, inhibiting or preventing the decomposing reaction caused by a radical species formed by light or heat, and for providing an ability such as moisture permeability and easily slipping ability.

On the other hand, decomposition reaction of the film constituting composition is accelerated by the thermal melting and the decomposition reaction accompanies coloration and caused by deterioration in the strength of the film constituting composition caused by the lowering in the molecular weight. Furthermore, formation of not preferable volatile component is sometimes accompanied with the decomposition reaction of the film constituting composition.

The presence of the above additives on the occasion of the thermal melting of the film constituting composition is advantageous for preventing the deterioration in the strength caused by the deterioration or the decomposition of the materials; therefore, the presence of the additives is necessary for producing the optical film of the invention.

The presence of the additives is superior for inhibiting formation of a substance coloring in the visible region on the occasion of thermal melting of the materials and for inhibiting and disappearing not preferable properties of the optical film such as lowering in the transparency and increasing in the haze caused by mixing of the volatile component in the film.

In the embodiment of the invention, the haze of the invention is less than 1% and preferably less than 0.5% because the image displayed on the display having the constitution of the invention is influenced when the haze of the optical film exceeds 1%.

In the course of production of the film and provision of the retardation ability to the film, it is necessary to inhibit deterioration in the strength of the film constituting material and keep the inherent strength of the material. When the film constituting material is made brittle by considerable deterioration, the film tends to be broken in the stretching process and the retardation value can not be controlled some times.

A deterioration reaction by oxygen in air is sometimes caused during the storage of the film constituting material or in the course of the film formation process. In such the case, a means for reducing oxygen concentration in air can be utilized together with the stabilizing effect of the above additive for realizing the embodiment of the invention. Know methods such as use of inert gas such as nitrogen and argon, deaeration for making reduced pressure or vacuum and operation in tightly closed atmosphere are applicable. At least one of the above three methods can be applied together with the method using the above additive. Such the methods are preferable for an object of the invention because the deterioration of the material can be inhibited by reducing the probability of contacting the film constituting material with oxygen in air.

The presence of the additives in the film constituting materials is preferable from the viewpoint of raising the aging stability of the polarizing plate and polarizing element constituting the plate relating to the invention because the retardation film relating to the invention is also applied as the protection film for the polarizing plate.

The liquid crystal display using the polarizing plate relating to the invention is made excellent by the presence of the additive in that the aging storage ability of the retardation film is improved by inhibition of the degradation and that the optical compensation ability designed for the retardation film can be held for long duration for raising the displaying quality of the liquid crystal display.

### (Plasticizer)

Addition of a compound known as the plasticizer is generally preferable from the viewpoint of improvement of the quality of the film such as improving in the mechanical property, providing softness and moisture resistivity and reducing in the moisture permeability. In the melt-casting method performed in the embodiment of the invention, the purpose of the addition of the plasticizer includes that the melting of the film constituting materials is made lower than the glass transition temperature of the cellulose ester itself and that the viscosity of the film constituting materials is made lower than that of the cellulose ester at the same heating temperature. In the present description, the melting temperature means a temperature of the materials in a state in which the materials is heated so as to have fluidity.

When the cellulose ester is used alone, the fluidity for film forming can not be obtained at temperature lower than the glass transition temperature thereof. However, the cellulose ester is lowered in the elastic modulus or viscosity and liquefied by absorbing heat at a temperature higher than the glass transition temperature thereof. For melting the film constituting material, the plasticizer to be added preferably has a melting point or a glass transition temperature lower than the glass transition point of the cellulose ester.

### (Compound Represented by Formula 1 or 2)

In the embodiment of the invention, a compound represented by the following Formula 1 or 2 is preferably used as the plasticizer.

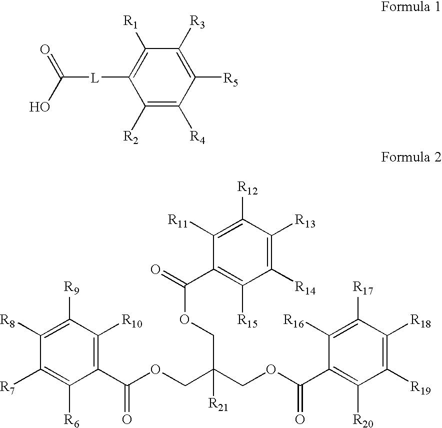

In the above Formula 1, R₁ to R₅ are each a hydrogen atom, a cycloalkyl group, an aralkyl group, an alkoxy group, a cycloalkoxy group, an aryloxy group, an aralkyloxy group, an acyl group, a carbonyloxy group, an oxycarbonyl group and an oxycarbonyloxy group, they may further have a substituent, and at least one of R₁ to R₅ is not hydrogen atom. L is a di-valent bonding group of a substituted or unsubstituted alkylene group, an oxygen atom or a direct bond.

The cycloalkyl group represented by R₁ to R₅ is preferably a cycloalkyl group having 3 to 8 carbon atoms, concretely a group such as a cyclopropyl group, a cyclopentyl group and cyclohexyl group. These cycloalkyl groups may be substituted; as the preferable substituent, a halogen atom such as a chlorine atom, a bromine atom and a fluorine atom, a hydroxyl group, an alkyl group, an alkoxy group, a cycloalkoxy group, an aralkyl group (the phenyl group of the aralkyl group may be substituted by an alkyl group or a halogen atom), a vinyl group, an alkenyl group such as a allyl group, a phenyl group (the phenyl group may be further substituted by an alkyl group or a halogen atom), a phenoxy group (the phenyl group of the phenoxy group may be substituted by an alkyl group or a halogen atom), an acyl group having 2 to 8 carbon atoms such as an acetyl group and propionyl group, and an unsubstituted carbonyloxy group having 2 to a carbon atoms such as an acetyloxy group and a propionyloxy group are cited.

The aralkyl group represented by R₁ to R₅ is a group such as a benzyl group, a phenetyl group and a γ-phenylpropyl group, and these groups may be substituted by a substituent. As the preferable substituent, groups the same as those cited as the group substitutable to the cycloalkyl group can be cited.

The alkoxy group represented by R₁ to R₅ is an alkoxyl group having 1 to 8 carbon atoms such as a methoxy group, an ethoxy group, an n-propoxy group, an n-butoxy group, an n-octyloxy group, an isopropoxy group, an isobutoxy group, a 2-ethylhexyloxy group and a t-butoxy group in concrete. These groups may have substituent and examples of the preferable substituent include a chlorine atom, a bromine atom, a fluorine atom, a hydroxyl group, an alkoxy group, a cycloalkoxy group, an aralkyl group (the phenyl group may be substituted by an alkyl group or a halogen atom), an alkenyl group, a phenyl group (the phenyl group may be substituted by an alkyl group or a halogen atom), an aryloxy group such as a phenoxy group (the phenyl group may be further substituted by an alkyl group or a halogen atom), an acyl group such as an acetyl group and a propionyl group, a unsubstituted acyloxy group having 2 to 8 carbon atoms such as an acetyloxy group and a propionyl oxy group, and an arylcarbonyloxy group such as a benzoyloxy group.

As the cycloalkoxy group represented by R₁ to R₅, an unsubstituted cycloalkyl group having 1 to 8 carbon atoms such as a cyclopropyloxy group and a cyclopentyloxy group is cited. These groups may have a substituent and the substituents the same as those substitutable to the above cycloalkyl group can be cited.

As the aryloxy group represented by R₁ to R₅, a phenoxy group can be cited, the phenoxy group may have a substituent the same as those substitutable to the above cycloalkyl group such as an alkyl group and a halogen atom.

As the aralkyloxy group represented by R₁ to R₅, a benzyloxy group and a phenethyloxy group can be cited. These substituents may be further substituted. As the substituent of the above groups, the groups the same as those substitutable to the above cycloalkyl group can be cited.

As the acyl group represented by R₁ to R₅, an unsubstituted acyl group having 2 to 8 carbon atoms such as an acetyl group and a propionyl group (the hydrocarbon group of the acyl group includes an alkyl group, an alkenyl group and an alkynyl group), and theses substituents may be further substituted by a substituent and the group the same as the groups substitutable to the above cycloalkyl group are cited as the preferable substituent.

As the carbonyloxy group represented by R₁ to R₅, an unsubstituted carbonyloxy group having 2 to 8 carbon atoms such as an acetyloxy group and a propionyloxy group (the hydrocarbon group of the acyl group includes an alkyl group, an alkenyl group and an alkynyl group) and an arylcarbonyloxy group such as a benzoyloxy group are cited, and theses substituents may be further substituted by the substituent the same as the groups substitutable to the above cycloalkyl group.

The oxycarbonyl group represented by R₁ to R₅ is an alkoxycarbonyl group such as a methoxycarbonyl group, an ethoxycarbonyl group and a propoxycarbonyl group, or an aryl carbonyl group such as a phenoxycarbonyl group Theses substituents may be further substituted by the substituent and the groups the same as those substitutable to the above cycloalkyl group are cited as the preferable substituent.

The oxycarbonyloxy group represented by R₁ to R₅ is an oxycarbonyl group having 1 to 8 carbon atoms such as a methoxycarbonyloxy group theses substituents may be further substituted by the substituent and the groups the same as those substitutable to the above cycloalkyl group are cited as the preferable substituent.

At least one the groups represented by R₁ to R₅ is not a hydrogen atom. Any of the groups represented by R₁ to R₅ are bonded with together to form a ring structure.

The bonding group represented by L is a an unsubstituted alkylene group, an oxygen atom, or a direct bonding, and the alkylene group is a group such as a methylene group, an ethylene group and a propylene group, and the groups may be substituted by a group cited as the group substitutable to the group represented by R₁ to R₅.

Particularly preferable group as the bonding group represented by L is the direct bonding and an aromatic carboxylic acid.

As the organic acid represented by Formula 1 which constitutes the ester compound to be used as the plasticizer in the embodiment of the invention, one having the above-described alkoxy group, acyl group, oxycarbonyl group, oxycarbonyloxy group as the group represented by R₁ or R₂ is preferable. The compounds having plural substituents are also preferable.

In the embodiment of the invention, the kind of the organic acid substituting the hydroxyl group of the tri- or more-valent alcohol may be single or plural.

In the embodiment of the invention, the tri- or more-valent alcohol for forming a polyvalent alcohol ester compound by reacting with the organic acid represented by Formula 1 is an aliphatic polyvalent alcohol, preferably 3- to 20-valent, and tri- or more valent alcohols represented by the following Formula 3 is preferred.

R′—(OH)ₘ Formula 3

In the above formula, R′ is an m-valent organic group, m is an integer of 3 or more, and OH is an alcoholic hydroxyl group. A polyvalent alcohol in which m is 3 or 4 is particularly preferable.

As preferable example of the polyvalent alcohol, the followings are cited but the alcohol is not limited to them. For instance, adonitol, arabitol, 1,2,4-butanetriol, 1,2,3-hexanetriol, 1,2,6-hexanetriol, glycerol, erythrirol, pentaerythritol, dipentaerythritol, tripentaerythritol, galactitol, glucose, cellobiose, inositol, mammitol, 3 methylpantane-1,3,5-triol, pinacol, sorbitol, trimethylolpropane, trimethylolethane, primethylolpropane and xylitol can be cited. Particularly, glycerol, trimethylolethane, trimethylpropane and pentaerythritol are preferred.

The ester of the organic acid represented by Formula 1 and the tri- or more-valent polyol can be synthesized by a known method. An esterification method in which the organic acid represented by Formula 1 and the polyol are condensed in the presence of an acid to form the ester, a method in which the organic acid is previously converted to derivative such as an acid chloride or an acid anhydrate and made react with the polyol, and a method in which a phenyl ester of the organic acid is made react with the polyol are applicable, and the typical synthesizing example is described in Examples. It is preferable that the synthesizing method with high yield is suitably selected according to the objective ester compound.

As the plasticizer composed of the ester of the organic acid represented by Formula 1 and the tri- or more-valent polyol is preferably a compound represented by Formula 2.

In the forgoing Formula 2, R₆ to R₂₀ are each a cycloalkyl group, an aralkyl group, an alkoxy group, a cycloalkoxy group, an aryloxy group, an aralkyloxy group, an acyl group, a carbonyloxy group, an oxycarbonyl group or an oxycarbonyloxy group, they may further have a substituent. At least one of R₆ to R₁₀ is not hydrogen atom, at least one of R₁₁ to R₁₅ is not hydrogen atom and at least one of R₁₆ to R₂₀ is not hydrogen atom. R₂₁ is an alkyl group.

As the cycloalkyl group, aralkyl group, alkoxy group, cycloalkoxy group, aryloxy group, aralkyloxy group, acyl group, carbonyloxy group, oxycarbonyl group and oxycarbonyloxy group represented by R₆ to R₂₁, the groups the same as that represented by R₁, to R₅ are cited.

The molecular weight of thus obtained polyol ester is preferably from 300 to 1,500 and more preferably from 400 to 1,000 though the molecular weight is not specifically limited. Higher molecular weight is preferable since higher molecular weight causes difficulty in the volatility and the lower molecular weight is preferable from the viewpoint of the moisture permeability and the compatibility with the cellulose ester.

Concrete compounds of the polyol ester relating to the invention are listed below.

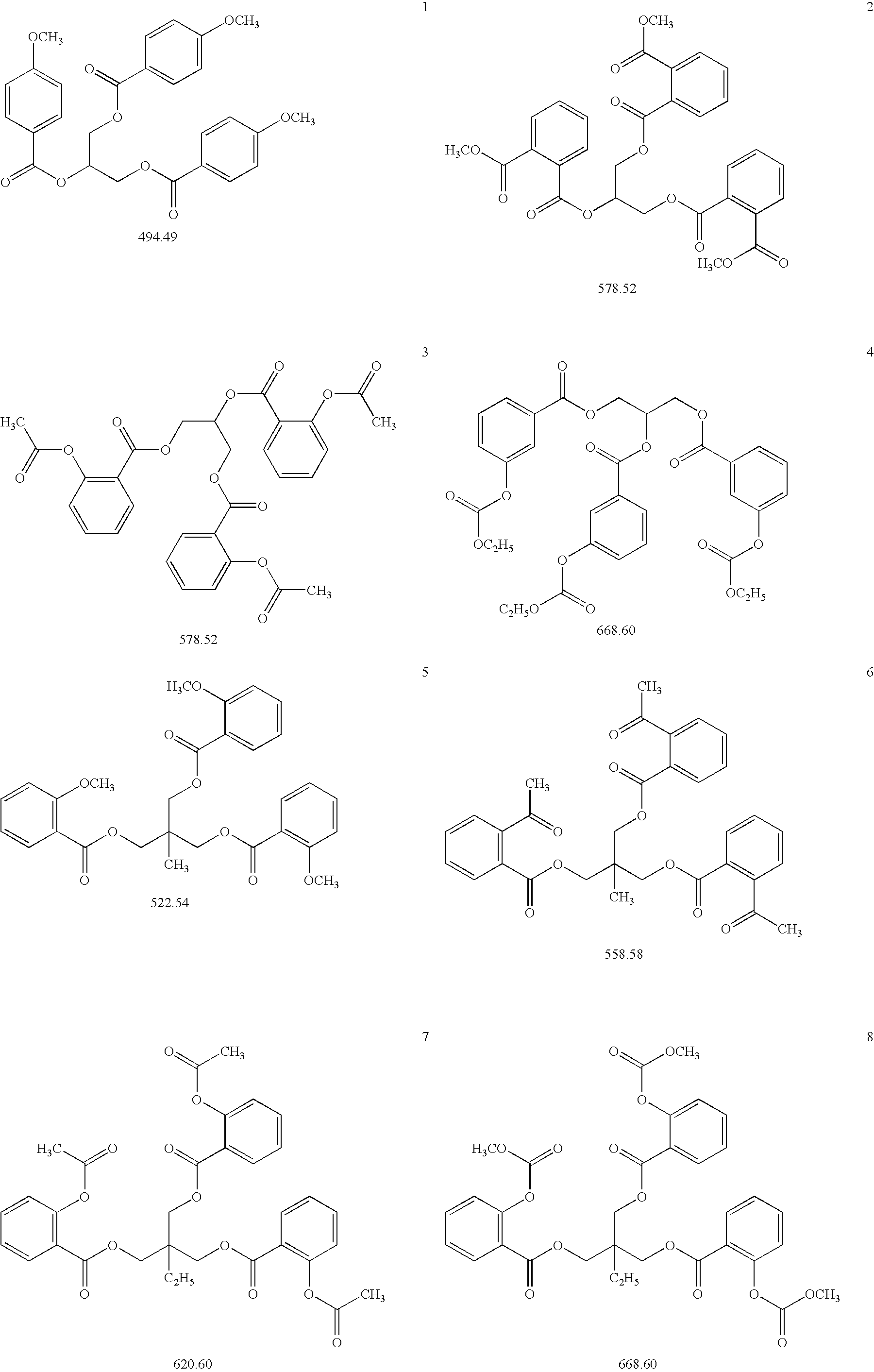

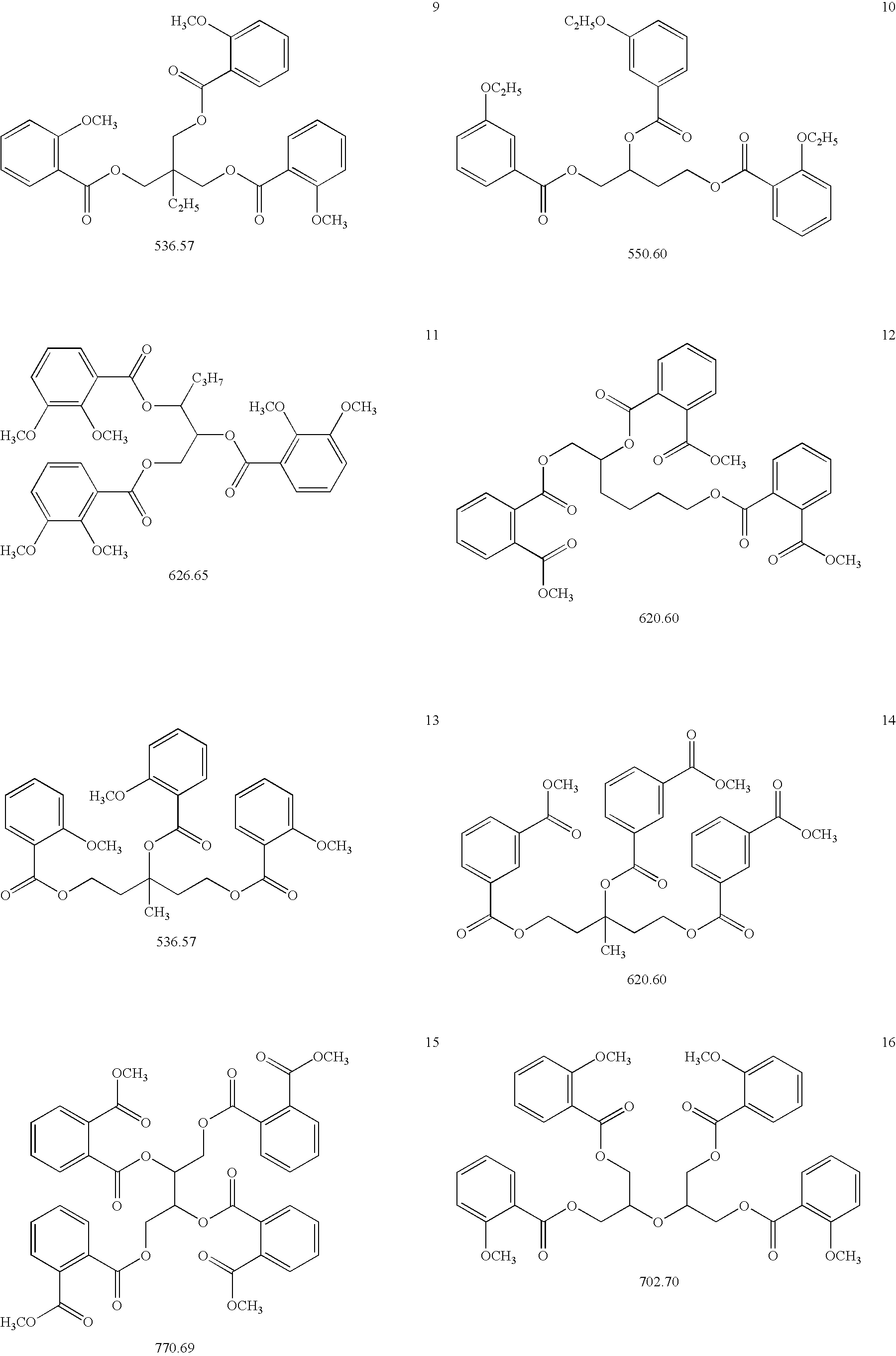

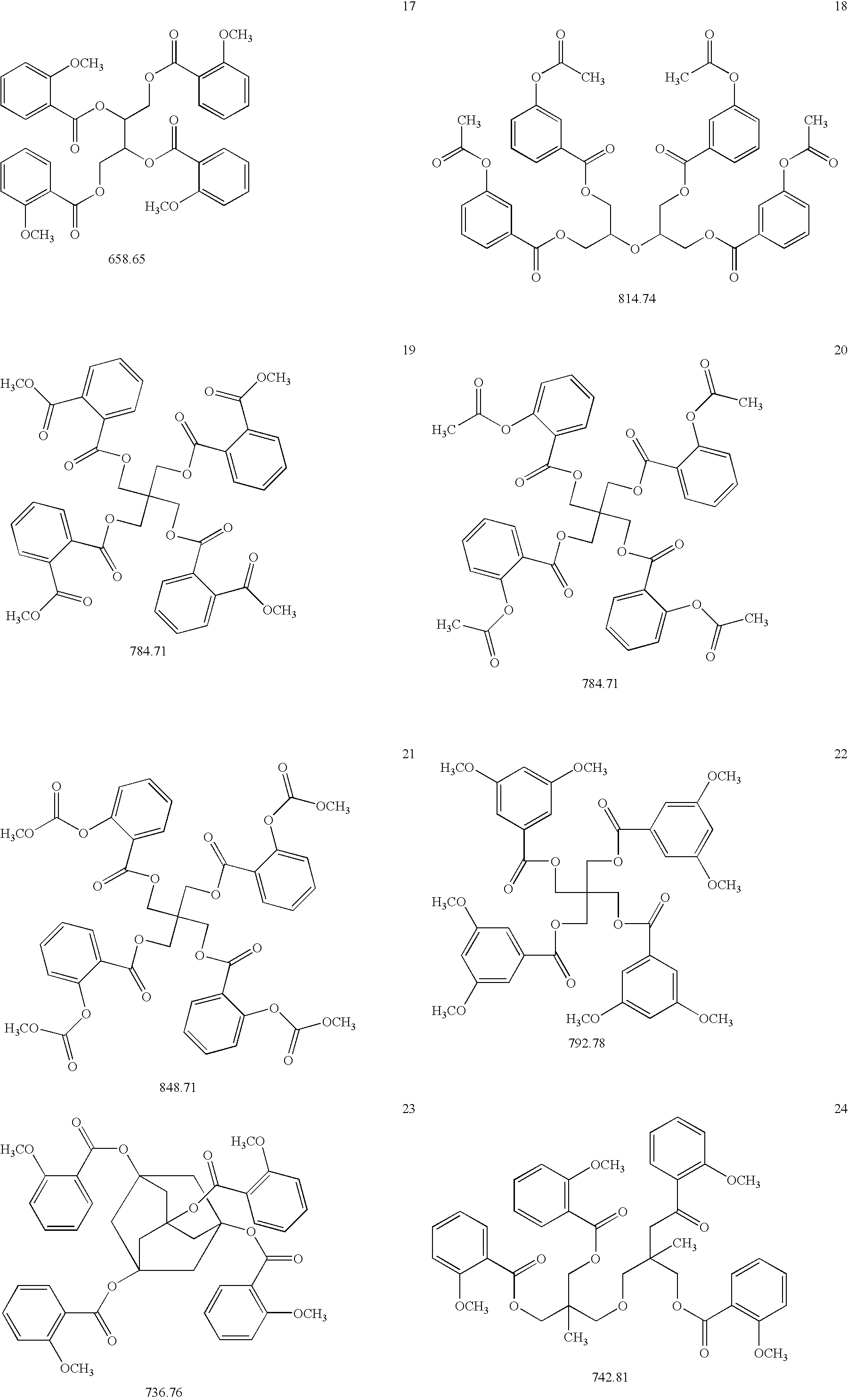

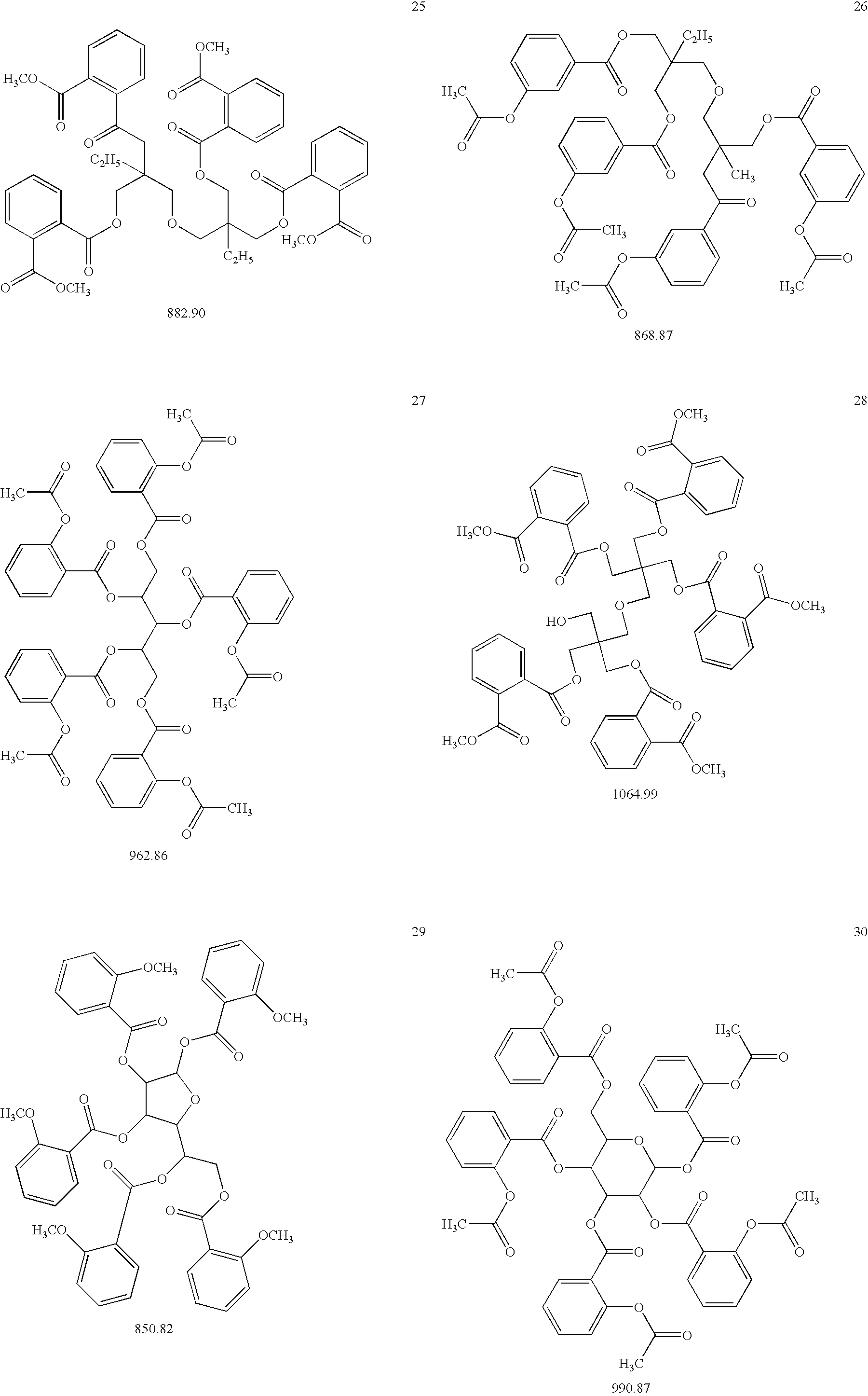

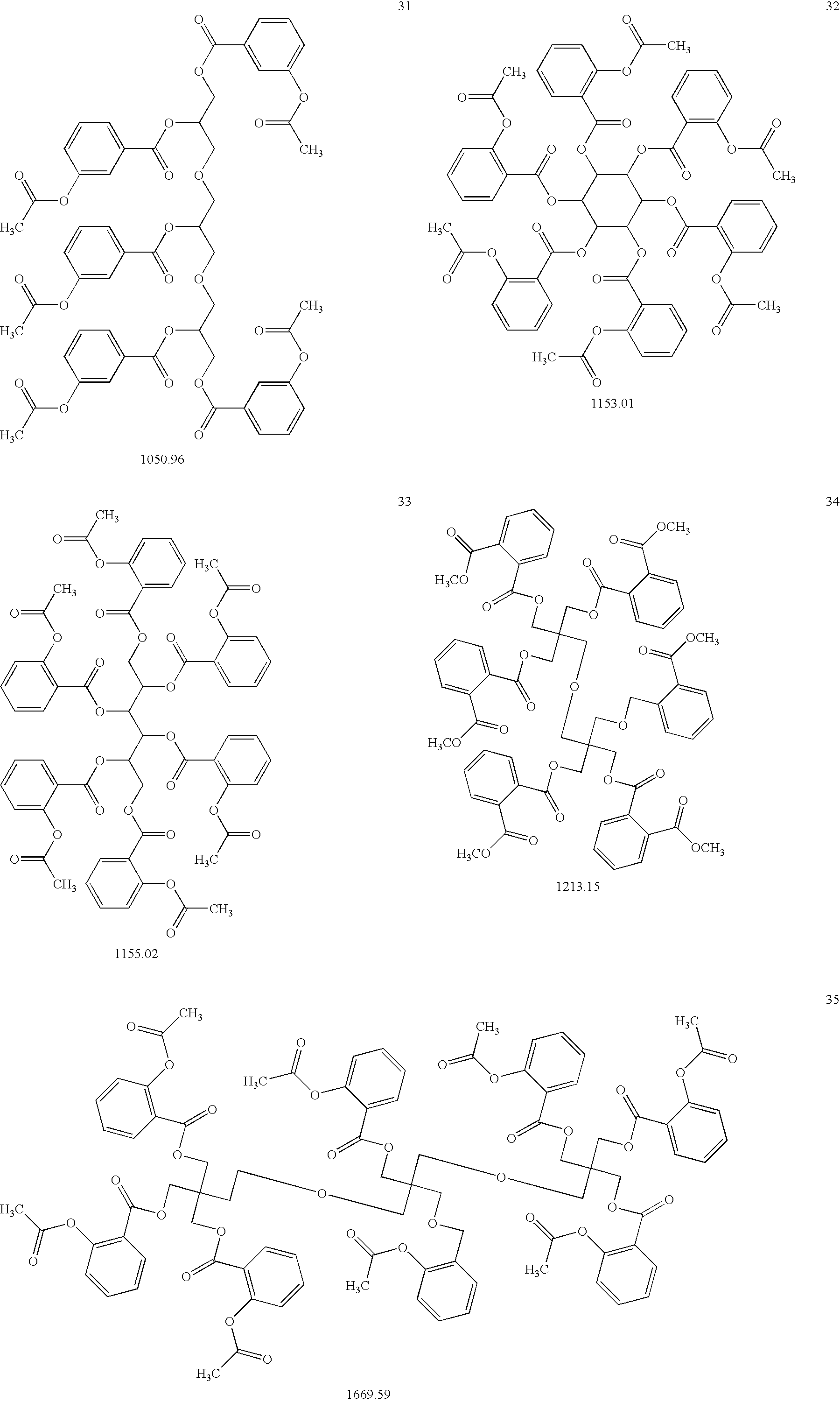

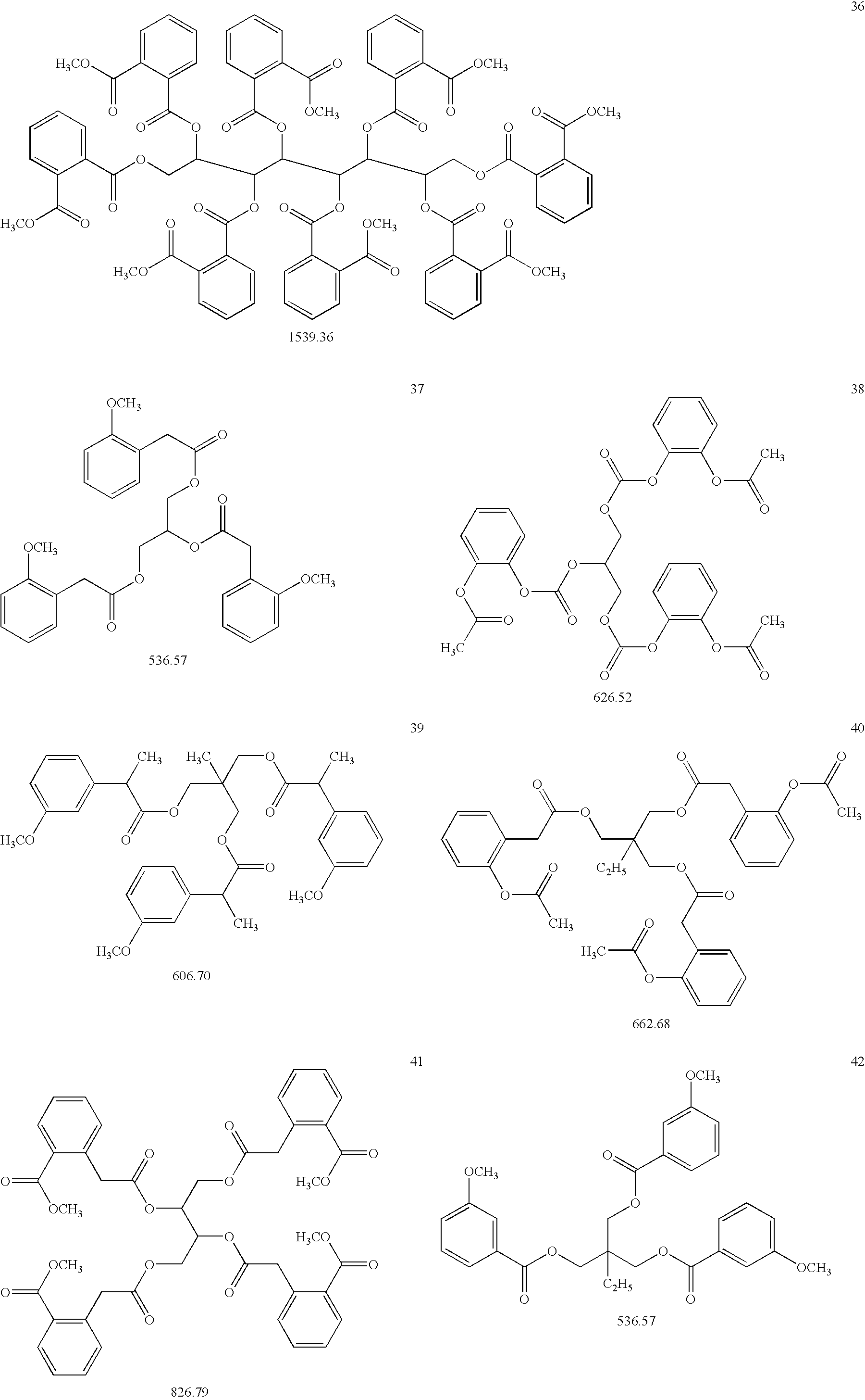

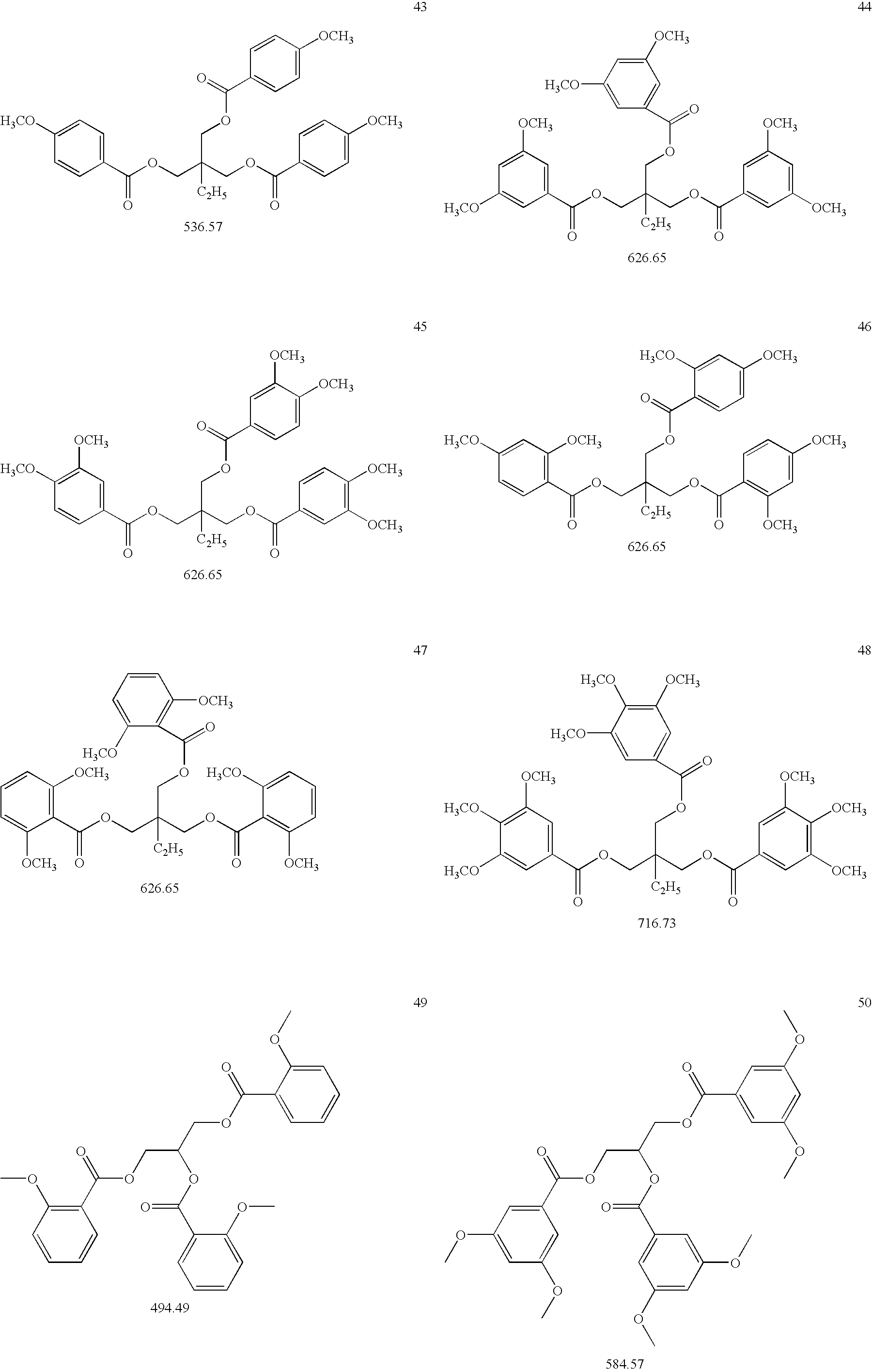

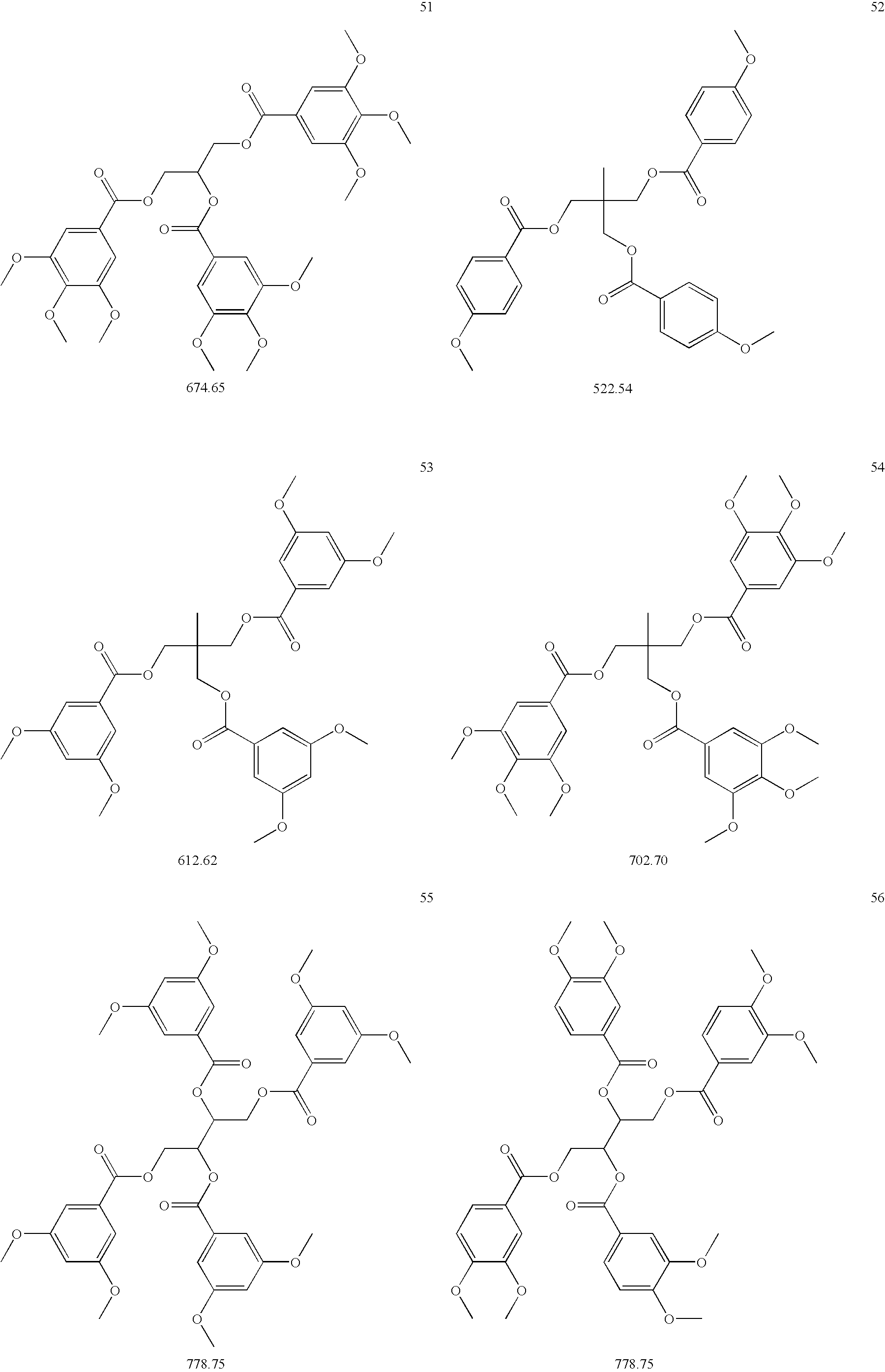

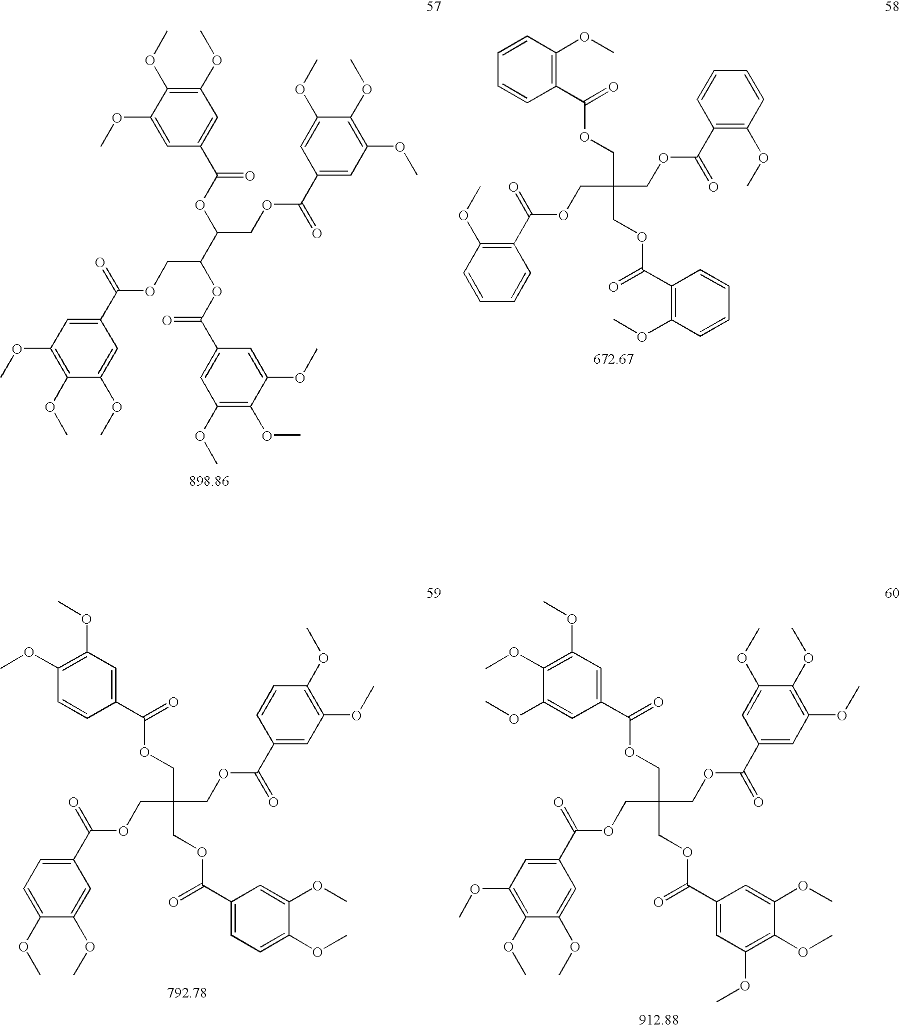

The cellulose film to be used in the embodiment of the invention contains the ester compound produced from the organic acid represented by Formula 1 relating to the invention and the tri- or more-valent polyol in an amount of from 1 to 25% by 7 weight as the plasticizer though another plasticizer may be used in combination.

The plasticizer relating to the invention namely the ester compound composed of the organic acid represented by Formula 1 and the tri- or more valent polyol has high compatibility with the cellulose ester and can be added in a high adding ratio, therefore, bleed out is not caused when the plasticizer is used in combination with another plasticizer or additives so that the plasticizer can be easily used together with another kind of plasticizer or additives.

### (Another Plasticizer)

It is preferable that the cellulose ester film at least contains the compound represented by Formula 1 or 2 in an amount 1 to 25% by weight and another plasticizer may be used in combination.

The compounds represented by Formula 1 or 2 have high compatibility with the cellulose ester and can be added in a high adding ratio, therefore, bleed out is not caused when the plasticizer is used in combination with another plasticizer or additives so that the plasticizer can be easily used together with another kind of plasticizer or additives.

When the other plasticizer is used, it is preferable that the plasticizer of the embodiment of the invention is contained in an amount of not less than 50%, more preferably not less than 70%, and further preferably not less than 80% of the entire plasticizer The bleed out and the moisture permeability can be improved by such the using amount even when the other plasticizer is used with together.

The followings are cited as the other plasticizer; a fatty acid-polyol ester type plasticizer, an unsubstituted aromatic acid- or cycloalkyl carboxylic acid-polyol ester type plasticizer such as that described in Tokkai 2003-12823, paragraphs 30 to 33, dioctyl adipate, dicyclohexane adipate, diphenyl succinate, di-2-naphtyl-1,4-cyclohexanedicarbonate, trihexyl-tricarbarate, tetra-3-methylphenyltetrahydrofuran-2,3,4,5-tetracarboxylate, tributyl 1,2,3,4-cyclopentane tetracarboxylate, triphenyl-1,3,5-cyclohexyltricarboxylate, triphenylbenzene-1,3,5-tetracarboxylate, a polyvalent carboxylic acid type plasticizer such as a phthalic acid type plasticizer such as diethyl phthalate, dimethoy diethylphthalate, dimethyl phthalate, dioctyl phthalate, dibutyl phthalate, di-2-ethylhexyl phthalate, dioctyl phthalate, dicyclohexyl phthalate, dicyclohexyl tetrephthalate, methylphthalyl methylglycolate, ethylphthalyl ethylglycolate, propylphthalyl propylglycolate and butylphthalyl butylglycolate, and a citric acid type plasticizer such as acetyltrimethyl citrate, acetyltriethyl citrate, and acetyltributyl citrate, and a phosphoric acid type plasticizer such as triphenyl phosphate, biphienyldiphenyl phosphate, butylene bis(diethylphosphate), ethylene bis(diphenylphosphate), phenylene bis(dibutylphosphate), phenylene bis(diphenylphosphate) (Adecastab PFR manufactured by Asahidenka Co., Ltd.), phenylene bis(dixylenylphosphate) (Adecastab FPS00 manufactured by Asahidenka Co., Ltd.) and bisphenol A diphenylphosphate (Adecastab FP600 manufactured by Asahidenka Co., Ltd.), a polyether plasticizer and the polymer polyester type plasticizer described in paragraphs 49 to 56 of Tokkai 2002-22956.

In the embodiment of the invention, a plasticizer selected from phthalic acid ester type plasticizers, polyvalent carboxylic acid ester type plasticizers, citric acid ester type plasticizers, polyester type plasticizers, polyether type plasticizers and an acryl resin plasticizers is preferably used and the additives described in paragraphs [0032] to [0049] of Tokkai 2003-12859 are more preferably usable.

Coloration of the cellulose ester film of the embodiment of the invention influences on the optical use thereof, and the yellowing degree (yellow index Y1) is preferably not more than 3.0 and more preferably not more than 1.0. The yellowing degree can be measured according to JIS-K7103,

### (Antioxidant)

The antioxidant preferably to be used in the embodiment of the invention is described bellow.

As the antioxidant, a phenol type antioxidant, a phosphoric acid type antioxidant, a sulfur type antioxidant, a thermal resistive processing stabilizing agent and an oxygen scavenger are cited. Among them, the phenol type antioxidant, particularly an alkyl-substituted phenol type antioxidant, is preferred. The coloring and the strength lowering of the formed product caused by heat and oxidation degradation on the occasion of the film formation can be prevented without degradation in the transparency and the thermal resistance by combining such the antioxidant. These antioxidants may be used solely or in combination of two or more kinds thereof, and the adding amount is preferably from 0.01 to 5 parts by weight and more preferably from 0.01 to 1 parts by weight to 100 parts by weight of cellulose ester relating to the invention though the amount can be suitably selected as long as the object of the invention is not vitiated.

As the antioxidant, a hindered phenol antioxidant compound is preferable, which include 2,6-dialkylphenol derivatives such as those described in columns 12 to 14 of U.S. Pat. No. 4,339,405. Such the compounds include ones represented by the following Formula 4.

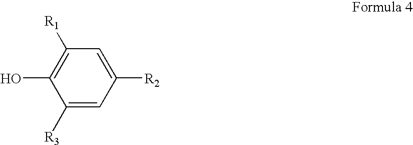

In the above formula, R₁, R₂ and R₃ are each a substituted or unsubstituted alkyl group. Concrete examples of the hindered phenol compound include n-octadecyl 3-(3,5-di-t-butyl-4-hydroxyhenyl)-propionate, n-octadecyl 3-(3,5-t-di-butyl-4-hydroxyphenyl)-acetate, n-octadecyl 3,5-di-t-butyl-4-hydroxybenzoate, n-hexyl 3,5-di-t-butyl-4-hydroxyphenylbenzoate, n-dodecyl 3,5-di-t-butyl-4-hydroxyphenylbenzoate, neo-dodecyl 3,5-di-t-butyl-4-hydroxyphenyl)propionate, dodecyl β(3,5-di-t-butyl-4-hydroxyphenyl)propionate, ethyl α-(4-hydroxy-3,5-di-t-butylphenyl)isobutylate, octadecyl α-(4-hydroxy-3,5-di-t-butylphenyl)isobutylate, octadecyl α-(4-hydroxy-3,5-di-t-butylphenyl) propionate), 2-(n-octylthio)ethyl 3,5-di-t-butyl-4-hydroxyl-benzoate, 2-(n-octylthio)ethyl 3,5-di-t-butyl-4-hydroxyphenylacetate, 2-(n-octylthio)ethyl 3,5-di-t-butyl-4-hydroxybenzoate, 2-(2-hydroxyethylthio)ethyl 3,5-di-t-butyl-4-hydroxybenzoate, diethylglycol bis-(3,5-di-t-butyl-4-hydroxyphenyl)propionate, 2-(n-octadecylthio)-ethyl 3-(3,5-di-t-butyl-4-hydroxyphenyl)propionate, stearylamido N,N-bis[ethylene-3-(3,5-di-t-butyl-4-hydroxy-phenyl)propionate], n-butylimino N,N-bis-[ethylene 3-(3,5-di-t-butyl-4-hydroxyphenyl)propionate]1,2-(2-stearoyloxyethyltho)ethyl 3,5-di-t-butyl-4-hydroxyhenzoate, 2-(2-stearoyloxyethylthio)ethyl 7-(3,5-di-t-butyl-4-hydroxyphenyl)heptanoate, 1,2-propylene-glycol bis-[3(3,5-di-t-butyl-4-hydroxyphenyl)propionate], ethyleneglycol bis[3-(3,5-di-t-butyl-4-hydroxyphenyl)propionate], neopentylglycol bis-[3-(3,5-di-t-butyl-4-hydroxyphenyl)propionate, ethyleneglycol bis-3,5-di-t-butyl-4-hydroxyphenylacetate, glycerol-1-n-octadecanoate-2,3-bis-(3,5-di-t-butyl-4-hydroxyphenylacetate), pentaerythritol tetrakis-3-[(3,5-di-t-butyl-4-hydroxyphenyl)propionate], 1,1,1-trimethylolethane tris-[3-(3,5-di-t-butyl-4-hydroxyphenyl)propionate, sorbitol hexa-[3-(3,5-di-t-butyl-4-hydroxyphenyl)propionate], 2-hydroxyethyl 7-(3,5-di-t-butyl-4-hydroxyphenyl)propionate, 2-stearoyloxyethyl 7-(3,5-di-t-butyl-4-hydroxyphenyl)-hepanoate, 1,6-n-hexanediol bis[((3,5-di-t-butyl-4-hydroxyphenyl)propionate] and pentaerythritol pentakis(3,5-di-t-butyl-4-hydroxyphenylcinnamate). The above-mentioned hindered phenol type antioxidant compounds are marketed by Ciba Specialty Chemicals under the trade name of Irganox 1076 and Irganox 1010, for example.

As another preferable phosphor type antioxidant, ones usually used in the field of resin industry are usable without specific limitation. A monophosphite type compound such as triphenyl phosphite, diphenyl isodecyl phosphite, phenyl diisodecyl phosphite, tris(nonylphenyl) phosphite, tris(dinonylphenyl)phosphite, tris(2,4-di-t-butylphenyl) Phosphite and 10-(3,5-di-t-butyl-4-hydroxybenzyl)-9,10-dihydro-9-oxa-10-phosphaphonanthrene-10-oxide; and a diphosphite type compound such as 4,4′-butylidene-bis(3-methyl-6-t-butylphenyl-di-tridecylphosphite) and 4,4′-isopropylidene-bis(phenyl-di-alkyl(C₁₂ to C₁₆)phosphite can be cited, Among them, monophosphite type compounds are preferable and tris(nonylphenyl)phosphite, tris(dinonylphenyl)phosphite and tris(2,4-di-t-butylphenylphosphite) are particularly preferred.

As preferable sulfur type stabilizer, for instance, dilauryl 3,3-thiodipropionate, dimyristyl 3,3′ thiopropionate, distearyl 3,3-ditiopropionate, lauryl stearyl 3,3-dithiopropionate, pentaerythritol tetrakis(β-lauryl-thio-propionate), 3,9-bis(dodecylthio-ethyl)-2,4,8,10-tetraoxaspiro[5,5]-undecane are cited.

Phosphor Type Compound

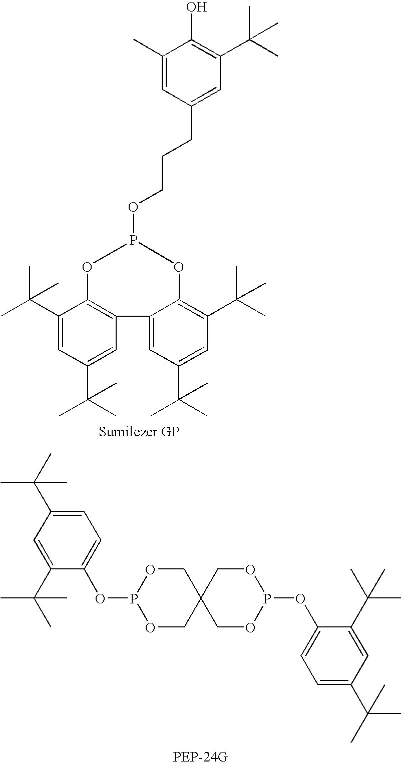

### Sulfur Type Compound

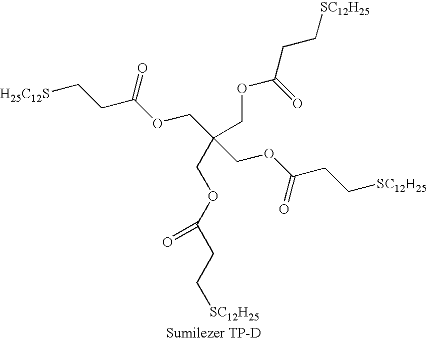

Sumilezer GP: Sumitomo Chemical Co., Ltd.

PEP-24G: Asahi Denka Kogyo Co., Ltd.

Sumilezer TP-D: Sumitomo Chemical Co., Ltd.

The heat resistive processing stabilizer such as 2-tert-butyl-6-(3-tert-butyl-2-hydroxy-5-methylbenzyl)-4-Methylphenylacrylate and 2-[1-(2-hydroxy3,5-di-tert-pentylphenyl)ethyl]-4,6-di-tert-penty; phenylacrylate, and a scavenger such as a 3,4-dihydro-2H-1-benzopyrane type compound described in Tokkai Hei 8-27508, a 3,3′-spirodichromane type compound, a 1,1-spiroindane type compound, a compound having a skeleton of morpholine, thiomorpholine, thiomorpholine oxide, thiomorpholine dioxide or piperazine as partial structure and a dislkoxybenzene type compound described in Tokkai Hei 3-174150 are cited. Such the partial structure of these antioxidants may be partially or regularly contained in polymer as a pendant or introduced into a part of the molecular structure of the plasticizer, acid scavenger or UV absorbent.

### (Acid Capturing Agent)

As the acid capturing agent, ones containing the epoxy compound described as the acid capturing agent in U.S. Pat. No. 4,137,201 are preferable Such the epoxy compounds as the acid capturing agent are known in the field of the art and typical examples thereof include diglycidyl ethers of various polyglycols, particularly a glycidyl ether of polyglycol or glycerol introduced condensation with ethylene oxide in an amount of from 8 to 40 moles per mole of polyglycol, a metal epoxy compound such as usually used in vinyl chloride polymer composition and together with vinyl chloride composition, an epoxy ether condensation product, glycidyl ether of bisphenol A (namely, 4,4′-dihydroxydiphenyldimethylmethne), an epoxidized unsaturated fatty acid ester (an ester of an alkyl group having about 2 to 4 carbon atoms, an aliphatic acid having 2 to 22 carbon atoms such as butylepoxy stearate) and triglyceride of various epoxidized long chain fatty acids such as epoxidized soy bean oil. The epoxidized plant oil and epoxidized another unsaturated natural oil are sometimes called as epoxidized natural glyceride or epoxidized unsaturated fatty acid and the fatty acid commonly contains 12 to 22 carbon atoms. An epoxy group containing epoxide resin compound EPON815c, manufactured by Miller-Stephenson Chemical Company Inc., available on the market and another epoxidized ether oligomer condensation product represented by Formula 5 are most preferable.

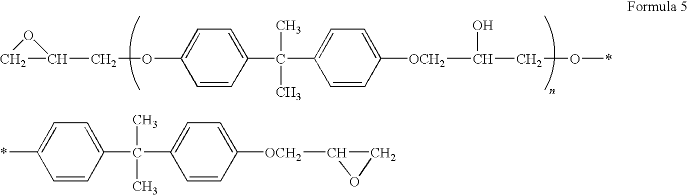

In the above formula, n is 0 to 12. The usable acid capturing anger includes those described in paragraphs 87 to 105 of Tokkai Hei 5-194788.

### (Photo Stabilizing Agent)

As the photo stabilizing agent, hindered amine compounds (HALS) are cited, which are known compounds and include, for example, 2,2,6,6-tetralkylpiperidine compounds, acid addition salt of them and metal complexes of them such as those described in U.S. Pat. No. 4,619,956, paragraphs 5 to 11, and U.S. Pat. No. 4,839,405, paragraphs 3 to 5. Such the compounds include ones represented by the following Formula 6.

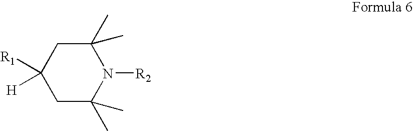

In the above formula, R₁ and R₂ are each a hydrogen atom or a substituent. Concrete examples of the hindered amine photo stabilizing agent include 4-hydroxy-2,2,6,6-tetramethyl-piperidine, 1-allyl-4-hydroxy-2,2,6,6-tetramethyl-piperidine, 1-benzyl-4-hydroxy-2,2,6,6-tetramethyl piperidine, 1-(4-t-butyl-2-butenyl)-4-hydroxy-2,2,6,6-tetramethylpiperidine, 4-stearoyloxyl-4-hydroxy-2,2,6,6-tetramethyl-piperidine, 1-ethyl-4-saliciloyloxy-2,2,6,6-tetramethylpiperidine, 4-methacryloyloxy-1,2,2,6,6-pentamethylpiperidine, 1,2,2,6,6-pentamethylpiperidine-4-yl-β-(3,5-di-t-butyl-4-hydroxyphenyl)-propionate, 1-benzyl-2,2,6,6-tetramethyl-4-piperidinylmaleinate, (di-2,2,6,6-tetramethylpieridine-4-yl)-adipate, (di-2,2,6,6-tetramethylpieridine-4-yl)-sebacate, (di-1,2,3,6-tetramethyl-2,6-diethyl-piperidine-4-yl)-sebacate, (di-1-allyl-2,2,6,6-tetramethyl-piperidine-4-yl)-phthalate, 1-acetyl-2,2,6,6-tetramethylpiperidine-4-yl-acetate, tri-2,2,6,6-tetramethyl-piperidine-4-yl trimellitate, 1-acryloyl-4-benzyloxy-2,2,6,6-tetramethylpiperidine, di-(1,2,2,6,6-pentamethylpiperidine-4-yl) molonate, di-(1,2,3,6-tetramethyl-2,6-diethylpiperidine-4-yl) dibenzyl-malonate, dimethyl-bis-(2,2,6,6-tetramethyl-piperidine-4-oxy)-silane, tris-(1-propyl-2,2,6,6-tetra-methylpiperidine-4-yl)-phosphite, tris-(1-propyl-2,2,6,6-tetramethyl-piperidine-4-yl)-phosphate, N,N′-his-(2,2,6,6-tetra-methylpiperidine-4-yl)-hexamethylen-1,6-diamine,N,N′-bis-(2,2,6,6-tetra-methyl-piperidine-4-yl)-hexamethylen-1,6-diacetamide, 1-acetyl-4-(cyclohexyl-acetamido)-2,2,6,6-tetramethylpiperidine, 4-benzylamino-2,2,6,6-tetramethylpiperidine, N,N′-bis-(2,2,6,6-tetramethyl-piperidine-4-yl)-N,N′-dibutyl-adipamide, N,N′-bis-2,2,6,6-tetramethyl-piperidine-4-yl-N,N′-dicyclohexyl-(2-hydroxy-propylene), N,N′-bis-(2,2,6,6-tetramethlpiperidine-4-yl)-p-xylylene-diamine, 4-(bis-2-hydroxyethyl)-amino-1,2,2,6,6-pentamethylpiperidine, 4-methacrylamido-1,2,2,6,6-pentamethylpiperidine and methyl α-cyano-β-methyl-β-[N-(2,2,6,6-tetramethlpiperidine-4-yl)-amino acrylate. Examples of the preferable hindered amine photo stabilizing agent include the following HALS-1 and HALS-2.

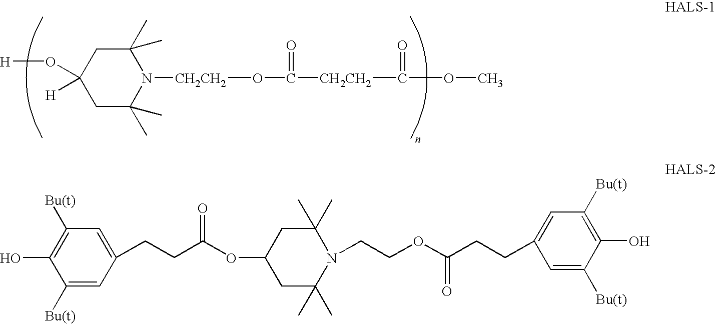

Such the hindered amine photo-resistivity stabilizing agent can be used solely or in combination of two or more kinds thereof, and the hindered amine photo-resistivity stabilizing agent may be used together with the additive such as the plasticizer, acid scavenger and UV absorbent or introduced into a part of the molecular structure of the additive. The adding amount of that can be suitably selected from the range in which an object of the invention is not vitiated, and is preferably from 0.01 to 10, more preferably from 0.01 to 506, and particularly preferably from 0.05 to 1%, by weight.

### (Ultraviolet Absorbent)

The ultraviolet absorbent preferably has excellent ultraviolet light absorbance for wavelengths not greater than 370 nm in view of preventing deterioration of the polarizer or the display device due to ultraviolet light, and from the viewpoint of the liquid crystal display it is preferable that there is little absorbance of visible light which has wavelength of not less than 400 nm. Examples of the ultraviolet absorbents include oxybenzophenone compounds, benzotriazole compounds, salicylic acid ester compounds, benzophenone compounds, cyano acrylate compounds nickel complex compounds and the like and benzophenone compounds as well as benzotriazole compounds which have little coloration are preferable. In addition, the ultraviolet absorbents described in JP-A Nos. 10-182621 and 8-337574, and the high molecular weight ultraviolet absorbents described in JP-A 6-148430 may also be used.

Examples of the benzotriazole based ultraviolet absorbents include 2-(2′-hydroxy-5′-methylphenyl)benzotriazole, 2-(2′-hydroxy 3′,5′-di-tert-butyl phenyl)benzotriazole, 2-(2′-hydroxy 3′-tert-butyl-5′-methylphenyl)benzotriazole, 2-(2′-hydroxy 3′,5′-di-tert-butyl phenyl)-5-chlorobenzotriazole, 2-(2′-hydroxy 3′-(3″,4″,5″,6″-tetrahydrophthalimide methyl)-5′-methylphenyl)benzotriazole, 2,2-methyl bis(4-(1,1,3,3-tetramethyl butyl)-6-(2H-benzotriazole-2-yl)phenyl), 2-(2′-hydroxy-3′-tert-butyl-5′-methylphenyl)-5-chlorobenzotriazole, 2-(2H-benzotriazole-2-yl)-6-(straight chain or side chain dodecyl)-4-methylphenyl, and mixtures of octyl-3-[3-tert-butyl-4-hydroxy-5-(chloro-2H-benzotriazole-2-yl)phenyl]propionate and 2-ethylhexyl-3-[3-tert-butyl-4-hydroxy-5-(5-chloro-2H-benzotriazole-2-yl)phenyl]propionate. The benzotriazole based ultraviolet absorbent is however, not limited to these examples.

Commercially available TINUVIN 109, TINUVIN 171, and TINUVIN 360 (each being manufactured by Chiba Specialty Chemical Co., Ltd.), LA-31 (manufactured by Asahi Denka Co., Ltd.) may also be used.

Examples of the benzophenone based compound include 2,4-hydroxy benzophenone, 2,2′-dihydroxy-4-methoxy benzophenone, 2-hydroxy-4-methoxy-5-sulfobenzophenone, bis (2-methoxy-4-hydroxy-5-benzoyl phenyl methane) and the like, but are not limited thereto.

The added amount of the ultraviolet absorbent in the cellulose ester film is preferably from 0.1 to 20% by weight, more preferably from 0.5 to 100 by weight, and still more preferably from 1 to 56 by weight. Two or more kinds of the ultraviolet absorbent may be used together.

### (Matting Agent)

Fine particles such as a matting agent or the like may be added to the cellulose ester film of the invention in order to impart a matting effect, and fine particles of inorganic compounds as well as fine particles of organic compounds may be used. The particles of the matting agent are preferably as fine as possible and examples of the fine particle matting agent include inorganic fine particles such as those of silicon dioxide, titanium dioxide, aluminum oxide, zirconium oxide, calcium carbonate, kaolin, talc, burned calcium silicate, hydrated calcium silicate, aluminum silicate, magnesium silicate, and calcium phosphate or cross-linked fine particles of high molecular weigh polymers of these, silicon dioxide is preferable in view of reduced haze in the film. The particles such as the silicon dioxide particles are often surface treated using an organic substance, and this is preferable because it reduces haze in the film.

Examples of the organic compound preferably used in the surface treatment include halogens, alkoxysilanes, silazanes, and siloxanes. Particles having a larger average particle diameter have a greater matting effect, while particles having a smaller average particle diameter have excellent transparency. The secondary particles have an average particle diameter in the range of 0.05 to 1.0 μm. The secondary particles preferably have an average particle diameter in the range of 5 to 50 nm, and more preferably 7 to 14 nm. These fine particles are preferable because they create unevenness of 0.01 to 1.0 μm in the plane of the cellulose ester film. The amount of the fine particles included in the cellulose ester is preferably 0.005 to 0.36 by weight.

Examples of the silicon dioxide particles include Aerosil 200, 200V, 300, R972, R972V, R974, R202, P812, OX50, or TT60 each manufactured by Nippon Aerosil Co., Ltd., and of these, Aerosil 200V, R972, R972V, R974, R202, and R812, are preferred. Two or more of these matting agents may be combined and used. In the case where 2 or more matting agents are used, they may be mixed in a suitably selected proportion. In this case, matting agents which have different particle diameter and quality such as Aerosil 200V and R972V may be used in weight proportions in the range from 0.1-99.9-99.9:0.1.

The presence of the fine particles used as the matting agent in the film can also serve another purpose of improving the strength of the film. The presence of the fine particles in the film may also improve the orientation of the thermoplastic resin itself, which constitutes the retardation film relating to the invention.

### (Retardation Controlling Agent)

In the retardation film relating to the invention, compounds having two or more aromatic rings such as those described in European Patent No. 911,656A2 can be used as a retardation controlling agent. Two or more kinds of the aromatic compounds may be used with together. The aromatic ring of the aromatic compound includes an aromatic heterocyclic ring additionally to an aromatic hydrocarbon ring. The aromatic heterocyclic ring is particularly preferable, which is generally an unsaturated heterocyclic ring. Among them, compounds containing a 1,3,5-triazine ring are particularly preferable.

### (Retardation Value)

The retardation film has the slow axis in the width direction and it is preferable that the in-plane retardation value Ro is from 30 to 100 nm at 589 nm and that in the thickness direction Rt is from 70 to 300 μm, and the ratio of Rt/Ro is from 2 to 5.

Ro=(nx−ny)×d

Rt={(nx+ny)/2−nz}×d

In the above, nx is an in-plane refractive index in a slow axis direction of the film, ny is an in-plane refractive index in a fast axis direction of the film, nz is the refractive index in the thickness direction of the film and d (nm) is the thickness of the film.

The variation and the distribution of the Rt value in the film is preferably less than ±10 nm, more preferably less than ±8 nm, further preferably less than ±5 nm, particularly preferable ±3 nm, and more particularly preferable ±1 nm. It is most preferably that Rt is not varied.

The retardation values Ro and Rt in this description are measured by an automatic double refractometer such as KOBRA-21ADH, manufactured by Oji Scientific Instruments, using light of wavelength of 589 nm under a condition of 23° C. and 55% RH.

The slow axis is preferably within the range of ±1° of the width direction or the length direction of the long bulk film. The angle is more preferably with ±0.7° in the width or length direction, further preferably within ±0.5° and particularly preferably within ±0.1°.

### (Dimensional Stability)

In the retardation film relating to the invention, the dimensional variation under 80° C. and 90% RH is preferably less than ±1.0%, and more preferably less than ±0.5% and particularly preferable less than ±01% when the dimension of the film stood for 24 hours under 23° C. and 55% RH is used as the standard.

In the case of that the retardation film relating to the invention is used as the protection film of the polarizing plate, if the retardation film has the variation exceeding to the above range, the absolute value of the retardation and the orientation angle of the polarizing plate are disagreed for the initial setting so that lowering in the displaying quality improving ability or degradation in the displaying quality is caused sometimes.

### (Amount of Remaining Solvent and Moisture in Film)

The remaining amount of organic solvent in the retardation film relating to the invention is stably less than 0.1% by weight because substantially no solvent is used in the film forming process. Therefore, the retardation film having stable flatness and Rt higher than those of the usual film can be provided. Particularly, the retardation film having stable flatness and Rt can be provided even when the film is in a state of long roll of 100 m or more. The length of the retardation film is not specifically limited and a length of 1,500 m, 2,500 m and 5,000 is preferably applied.

The remaining amount of the organic solvent can be measured by a head space gas chromatographic method. Namely, a known amount of the retardation film is heated at 120° C. for 20 minutes in a closed container and the gas contained in the container is subjected to quantitative analysis by the gas chromatography. The remaining amount of organic solvent in percent can be calculated from thus obtained result.

When the film contains moisture, the amount (g) of the moisture is measured by another method and the remaining organic solvent can be determined by calculating the difference between the reduced weight (g) of the film after the foregoing heating and the moisture weight (g).

The remaining amount of organic solvent in a retardation film produced by the solution casting method can be difficultly made 0.1% by weight or less and a long drying process is necessary for that However, the retardation film having extremely low remaining amount of organic solvent can be produced with low cost by this method.

Decomposition reaction of the film constituting material is considerably cased on the occasion of melting by heat and the decomposition reaction sometimes accompanies coloring and degradation of the film. Moreover, occurrence of non-preferable volatile ingredient is sometimes caused by the decomposition reaction.

### (Cycloolefin Type Resin Film)

Cycloolefin resin, hereinafter referred to as cycloolefin polymer, preferably used in the embodiment of the invention is described bellow.

The cycloolefin polymer is composed of polymer resin containing an alicyclic structure.

The preferable cycloolefin polymer is a resin formed by polymerization or copolymerization of a cyclic olefin. As the cyclic olefin, a polycyclic unsaturated hydrocarbon and its derivative such as norbornene, cyclopentadiene, tetracyclododecene, ethyltetracyclododecene, ethylidenetetracyclododecene and tetracyclo[7.4.0.110,13.02,7]trideca-2,4,6,11-tetraene; and a single cyclic unsaturated and it derivative such as cyclobutene, cyclopentene, cyclohexane, 3,4-dimethylcyclopentene, 3-methylcyclohexene, 2-(2-methylbutyl)-1-cyclohexene, cyclooctene, 3a,5,6,7a-tetrahydro-4,7-methano-1H-indene, cyclohexane and cyclohexadiene are cited. These cyclic olefins each may have a polar group as the substituent. As the polar group, a hydroxyl group, a carboxyl group, a an alkoxyl group, an epoxy group, a glycidyl group, an oxycarbonyl group, a carbonyl group, an amino group, an ester group and a carboxylic acid anhydride group are applicable and the ester group, carboxyl group and carboxylic acid anhydride group are suitable.

The preferable cycloolefin may be one formed by additional polymerization with a monomer other than the cyclic olefin. As the additionally polymerizable monomer, ethylene or a α-olefin such as ethylene, propylene, 1-butene and 1-penten; and a diene such as 1,4-hexadiene, 4-methyl-1,4-hexadiene, 5-methyl-1,4-hexadiene and 1,7-octadiene are cited.

The cyclic olefin is obtained by an additional polymerization reaction or a metathesis ring-opening polymerization reaction. The polymerization is performed in the presence of a catalyst. As the catalyst for the additional polymerization, a polymerization catalyst composed of a vanadium compound or an organic aluminum compound is usable for example. As the catalyst for the ring-opening polymerization, a polymerization catalyst composed of a halide, nitrate or acetylacetone compound of a metal such as ruthenium, rhodium, palladium, osmium, iridium and platinum, and a reducing agent; and a polymerization catalyst composed of a halide or acetylacetone compound of a metal such as titanium, vanadium, zirconium, tungsten and molybdenum and an organic aluminum compound are cited. The polymerization is usually performed at a temperature of from −50° C. to 100° C. and a pressure of from 0 to 490 N/cm² though the temperature and the pressure are not specifically limited.

The cycloolefin polymer to be used in the embodiment of the invention is preferably one produced by polymerizing or copolymerizing the cyclic olefin and then subjecting to hydrogen adding reaction to change the unsaturated bond in the molecule to saturated bond. The hydrogen adding reaction is performed by blowing hydrogen in the presence of a known hydrogenation catalyst. As the hydrogenation catalyst, an uniform type catalyst composed of a combination of transition metal compound/alkyl metal compound such as those composed of a combination of cobalt acetate/triethylaluminum, nickel acetylacetonate/triisobutylaluminum, titanocene dichloride/n-butyllithium, zirconocene dichloride/sec-butyllithium and tetrabutoxytitanate/domethylmagnesium; and an ununiform type metal catalyst such as nickel, palladium and platinum; and an ununiform type catalyst composed of a metal catalyst carried by a carrier such as nickel/silica, nickel/diatomite, nickel/alumina, palladium/carbon, palladium/silica, palladium/diatomite and palladium/alumina are cited.

Moreover, the following norbornene type polymers are also cited as the cycloolefin polymer. It is preferable that the norbornene type polymer has a norbornene skeleton as the repeating unit, and concrete examples of which described in Tokkai Sho 62-252406, 62-2S2407, 63-145324 and 63-264626, Tokko Sho 57-8815, and Tokkai Hei 2-133413, 1-240517, 5-39403, 5-43663, 5-43834, 5-70655, 5-279554, 5-205985, 7-62028, 8-176411 and 9-241484 are preferably used but the polymer is not limited to the above-mentioned They may be used solely or in combination of two or more kinds.

In the embodiment of the invention, norbornene type polymers having a repeating unit represented by one of the following Formulas I to IV are preferable

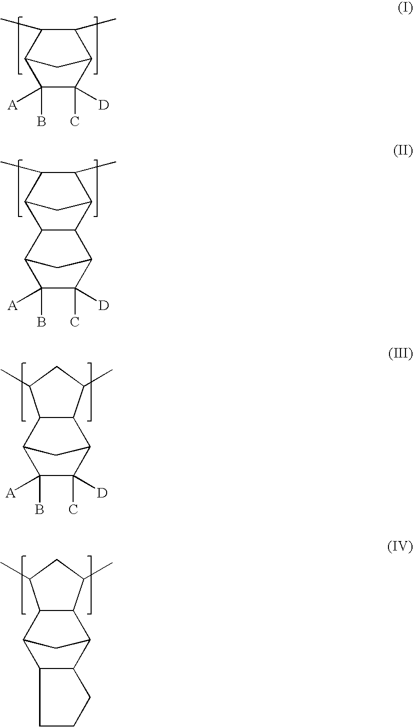

The above Formula I to IV, A, B, C and D are each independently a hydrogen atom of a mono-valent organic group.

Among the foregoing norbornene type polymer, a hydrogenated polymer formed by hydrogenation of a polymer obtained by metathesis polymerization of at least one kind of the compound represented by Formula V or VI and an unsaturated cyclic compound polymerizable with that is also preferable.

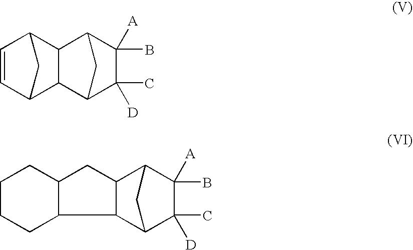

The above Formulas, A, B, C and D are each independently a hydrogen atom of a mono-valent organic group.

The above A, B, C and D are each preferably a hydrogen atom, a halogen atom, a mono-valent organic group or an organic group bonded through a di- or more-valent bonding group though they are not specifically limited. They may be the same or different. The di- or more-valent bonding group is include a hetero atom, typically an oxygen atom, a sulfur atom and a nitrogen atom, for instance an ether, ester, carbonyl urethane, amide and thioether are applicable but the group is not limited to them. The organic group may be substituted through the bonding group.

As the other monomer polymerizable with the norbornene type monomer, for example, an α-olefin having 2 to 20 carbon atoms such as ethylene, propylene, 1-butene, 1-pentene, 1-hexene, 1-octene, 1-decene, 1-dodecene, 1-tetradecene, 1-hexadecene, 1-eicocene and a derivative thereof; a cycloolefin such as cyclobutene, cyclopentene, cyclohexane, cyclooctene 3a,5,6,7a-tetrahydro-4,7-methane-1H-indene and a derivative thereof; and a non-conjugated diene such as 1,4-hexadiene, 4-methyl-1,4-hexadiene, 5-methyl-1,4-hexadiene and 1,7-octadiene are usable. Among them, α-olefin, particularly ethylene is preferred.

Such the other monomer copolymerizable with the norbornene type monomer can be used solely or in combination of two or more kinds thereof. When the norbornene type monomer is additionally copolymerized with the other copolymerizable monomer, the ratio of the structural unit derived from the norbornene type monomer to that derived from the other copolymerizable monomer in the copolymer is suitably selected so as to be usually from 30:70 to 99:1, preferably from 50:50 to 97:3, and more preferably from 70:30 to 95:5, in the weight.

When the unsaturated bond remaining in the synthesized polymer chain is saturated by the hydrogenating reaction, the hydrogenation ratio is made not less than 90%, preferably not less than 95%, and particularly preferably nor less than 99%, from the viewpoint of the resistivity to degradation caused by light and weather.

As the cycloolefin polymer to be used in the embodiment of the invention, the thermoplastic saturated norbornene type resin described in Tokkai Hei 5-2108, paragraphs [0014]-[0019], the norbornene type polymer described in Tokkai 2001-277430, paragraphs [0015]-[0031], the thermoplastic norbornene type polymer described in Tokkai 2003-14901, paragraphs [0008]-[0045], the norbornene type resin composition described in Tokkai 2003-139950, paragraphs [0014]-[0028], the norbornene type resin described in Tokkai 2003-161832, paragraphs [0029]-[0037], the norbornene type resin described in Tokkai 2003-195268, paragraphs [0027]-[0036], the alicyclic structure-containing polymer resin described in Tokkai 2003-211589, paragraphs [0009]-[0023], and the norbornene type polymer resin and vinyl alicyclic hydrocarbon polymer resin described in Tokkai 2003-211588, paragraphs [0008]-[0024], are cited.

In concrete, Zeonex and Zeonoa manufactured by Zeon Corp., and Apel APL8008T, APL6509T, APL6013T and APL6015T, manufactured by Mitsubishi Chemicals Inc., are preferably used.

The molecular weight of the cycloolefin polymer to be used in the embodiment of the invention can be suitably selected according to the purpose of use, the weight average molecular weight in terms of polyisoprene or polystyrene measured by gel permeation chromatograph of a cyclohexane solution (a toluene solution when the resin is insoluble in cyclohexane) is usually from 5,000 to 500,000, preferably from 8,000 to 200,000, and more preferably from 10,000 to 100,000, because the mechanical strength of the formed product and the easiness of the formation are highly balanced in such the region.

Decomposition and coloring of the polymer in the shape forming process can be effectively prevented by adding a low volatile antioxidant in a ratio of from 0.01 to 5 parts by weight to 100 parts by weight of the cycloolefin polymer.

The cycloolefin polymer can be produced by the following method, for example.

In a nitrogen atmosphere, 500 parts of dehydrated cyclohexane, 1.2 parts of 1-hexene, 0.15 parts of dibutyl ether, and 0.30 parts of triisobutylaluminum were charged into a reaction vessel and mixed at room temperature, and then a norbonene type monomer mixture composed of 20 parts of tricycle[4.3.0.12,5]deca-3,7-diene (dicyclopentaene, hereinafter referred to as DCP), 140 parts of 1,4-methano-1,4,4a,9a-tetrahydrofluorene (hereinafter referred to as MTF) and 40 parts of 8-methyl-tetracyclo-[4.4.0.12,5.17,10]-dodeca-3-ene (hereinafter referred to as MTD) and 40 parts of tungsten hexachlride (0.7% toluene solution) were continuously added spending 2 hours while maintaining the liquid temperature at 45° C. to make the polymerization reaction. To the polymerization reaction solution, 19.6 parts of butyl glycidyl ether and 0.25 parts of isopropyl alcohol were added for stopping the polymerization reaction by inactivating the polymerization catalyst.

After that, 270 parts of cyclohexane and then 5 parts of nickel-alumina catalyst, manufactured by Nikki Chemical Co., Ltd., as a hydrogenation catalyst were added to thus obtained reaction solution containing a ring-opening copolymer, and heated by 200° C. while stirring under a pressure of 5 MPa of hydrogen gas and were made to react for 4 hours. Thus a reaction liquid containing a hydrogenated DPC/MTF/MTD ring opening polymerized polymer in a concentration of 20% was obtained. The liquid was filtered for removing the hydrogenation catalyst and a soft polymer (Septon 2002 manufactured by Kraray Co., Ltd.) and an antioxidant (Irganox 1010 manufactured by Ciba Specialty Chemicals Inc.) were added each in an amount of 0.1 parts to 100 parts of the polymer and dissolved. Then volatile ingredients such as cyclohexane as the solvent and others were removed form the solution by using a cylindrical concentrating dryer, manufactured by Hitachi Ltd., and the hydrogenated polymer in a melted state was extruded from an extruder into a strand state and pelletized after cooling to prepare the cycloolefin type polymer.

As the antioxidant, ones having a vapor pressure at 20° C. of not more than 10⁻⁵ Pa are preferable and those having a vapor pressure of not more than 10⁻² Pa are particularly preferable. The antioxidants having a vapor pressure of higher than 10⁻⁵ Pa causes problems such as that bubbles are formed on the occasion of forming by extrusion or the antioxidant is volatized from the surface of the formed product when the product is exposed to high temperature.

As the antioxidant usable in the embodiment of the invention, the following can be exemplified. The may be used solely or in combination of several kinds thereof.

Hindered phenol type: 2,6-di-t-butyl-4-methylphenol, 2,6-di-t-butylphenol, 4-hydroxymethyl-2,6-di-t-butylphenol, 2,6-di-t-butyl-α-methoxy-p-dimethyl-phenol, 2,4-di-t-amylphenol, t-butyl-m-cresol, 4-t-butylphenol, styrenized phenol, 3-t-butyl-4-hydroxyanisole, 2,4-dimmethyl-6-t-butylphenol, octadecyl-3-(3,5-di-t-butyl-4-hydroxyphenyl)propionate, diethyl 3,5-di-t-butyl-4-hydroxy-benzylphosphonate, 4,4′-bisphenol, 4,4′-bis(2,6-di-t-butylphenol), 2,2′-methylene-bis-(4-methyl-6-t-butylphenol), 2,2′-methylene-bis-(4-methyl-6-αmethylcyclohexylphenol), 4,4′-methylene-bis-(2-methyl-6-t-butylphenol, 4,4′-methylene-bis-(2,6-di-t-butylphenol), 1,1′-methylene-bis-(2,6-di-t-butylnaphthol), 4,4′-butylidene-bis-(2,6-di-t-butyl-methacresol, 2,2′-thio-bis-(4-methyl-6-t̂butylphenol), di-o-cresolsulfide, 2,2′-thio-bis-(4-methyl-6-t-butylphenol, 4,4′-thio-bis(3-methyl-6-t-butylphenol), 4,4′-thio-bis-(2,3-di-sec-amylphenol), 1,1′-thio-bis (2-naphthol), 3,5-di-t-butyl-4-hydroxybenzylether, 1,6-hexanediol-bis-[3-(3,5-di-t-butyl-4-hydroxyphenyl)propionate], 2,4-his-(n-octylthio)-6-(4-hydroxy-3,5-di-t-butylanilino)-1,3,5-triazine, 2,2-thio-diethylenebis [3-(3,5-di-t-butyl-4-hydroxyphenyl)propionate]2,2-thiobis-(4-methyl-6-t-butylbutylphenol), N,N′-hexamethylenebis-(3,5-di-t-butyl-4-hydroxy-hydrocinnamide, bis(ethyl 3,5-di-t-butyl-4-hydroxybenzylsulfonate)calcium, 1,3,5-trimethyl-2,4,6-tris-(3,5-t-butyl-4-hydroxybenzyl)benzene, triethyleneglycol-bis[3-(3-t-butyl-5-methyl-4-hydroxyphenyl)propionate], 1,3,5-trimethyl-2,4,6-tris(3,5-di-t-butyl-4-hydroxybenzyl)benzene, tris-(3,5-di-t-butyl-4-hydroxybenzyl)-isocyanulate, and pentaerythrityl-tetrakis[3-(3,5-di-t-butyl-4-hydroxyphenyl)propionate

Aminophenol type: Normalbutyl-p-aminopenol, normalbutyloyl-p-aminophenol, normalperagonoyl-p-aminophenol, normaorauloyl-p-aminophenol, normalstearoyl-p-aminophenol, 2,6-di-t-butyl-α-dimethyl, and amino-p-aminophenol

Hydroquinone type: Hydroquinone, 2,5-di-t-butyl-hydroquinone, 2,5-di-t-amylhydroquinone, hydroquinone methyl ether, and hydroquinone monobenzyl ether

Phosphite type triphosphite: tris(3,4-di-t-burylphenyl)-phosphite, tris(nonylphenyl)phosphite, tetrakis(2,4-di-t-butylphenyl)-4,4′-biphenylenephosphanite, and 2-ethylhexyloctylphosphite

Others: Zinc salt of 2-mercaptothiazole, di catecholborate-di-o-tolylguanidine salt, nickel-pentamethyleneditioncarbanate, mercaptobenzimidazole, and 2-mercaptobenzimidazole zinc salt

The cycloolefin polymer film may contain additives usually usable in plastic film according to necessity. As such the additives, a thermal stabilizing agent, a light resistivity stabilizing agent, a WV absorbent, an anti-static agent, a lubricant, and a filler are cited. The adding amount of them can be selected from the range in which the purpose of the invention is not impeded.

The method for forming the cycloolefin polymer film is not specifically limited and both of a thermal melt-forming method and a solution casting method can be utilized. The thermal melt-forming method can be classified in detail into an extrusion forming method, a press forming method, an inflation forming method, an ejection forming method, a blow formation method and a stretch out method. Among them, the extrusion method, inflation method and press method are preferable and the extrusion method is most preferable for obtaining the film excellent in the mechanical strength and the surface precision. The film formation condition is suitably selected according to the purpose of use and the formation method. In the case of the thermal melt forming method, the cylinder temperature is suitably set within the range of from 150 to 400° C., preferably from 200 to 350° C., and more preferably from 230 to 330° C. When the temperature is excessively low, the fluidity is lowered so that distortion occurs in the film and when temperature is too high, voids and silver streak caused by thermal decomposition and yellow coloring of the film tend to occur. The thickness of the film is usually from 5 to 300 μm, preferably 10 to 200 μm, and more preferably from 20 to 100 μm. When the thickness is larger than the lower limit of the above range, the difficulty of the handling for laminating the film can be prevented and when the thickness is smaller than the upper limit of the above range, the drying time after the lamination is shortened so as to prevent lowering in the production coefficient.

The wetting tension of the surface of the cycloolefin polymer film is preferably not less than 40 mN/m, more preferably not less than 50 mN/m, and further preferably not less than 55 mN/m. When the wetting tension of the surface is within the above range, the adhesiveness between the film and the polarizing plate is raised. For controlling the wetting tension of the surface, known surface treatments such as corona discharge treatment, ozone blowing, UV irradiation, flame treatment and chemical treatment can be applied.

The sheet before the stretching requires a thickness of about 50 to 500 μm, and the ununiformity of the thickness is preferably as small as possible, the fluctuation of the thickness in entire surface is not more than ±8%, preferably not more than ±6%, and more preferably not more than ±4%.

For making the cycloolefin polymer film to the retardation film suitable for the invention, the same method as in the cellulose ester film is applied.

The stretching ratio is from 1.1 to 10, preferably from 1.3 to 8, and the film may be treated within the above range so as to obtain desired retardation value. Sufficient absolute retardation value can be obtained when the stretching ratio is not lower than the lower limit of the above range and the breaking of the film can be prevented when the stretching ratio is not higher than the above upper limit of the above range.

Thus obtained film can obtain desired retardation value by orientation of the molecules by the stretching. In the embodiment of the invention the in-plane retardation value Ro is from 30 to 100 nm, and preferably from 50 to 100 nm, at 599 nm. The retardation value Rt in the thickness direction is from 70 to 300 nm and preferably from 100 to 250 nm. Particularly, the ratio of Rt/Ro is preferably within the range of from 2 to 5.

The retardation can be controlled by the retardation of the sheet before the stretching, the stretching ratio, and the thickness of the film oriented by stretching When the sheet before the stretching is a certain thickness, the absolute value of retardation tends to be raised accompanied with the increasing in the stretching ratio. Therefore, the film oriented by stretching having desired retardation can be obtained by varying the stretching ratio.

The fluctuation of the retardation value is preferably as small as possible and the fluctuation of retardation at 589 nm of the cycloolefin polymer film relating to the invention is usually not more than ±10 nm, preferably not more than ±5, and more preferably not more than ±1 nm.

The fluctuation of the in-plane retardation and the ununiformity of the thickness can be reduced by using the sheet before stretching reduced in these values and uniformly applying stress on the occasion of the stretching. For such the purpose, it is preferred that the stretching is carried out under uniform temperature distribution, preferably not more than ±5° C., more preferably not more than ±2° C., and particularly preferably not more than ±0.5° C.

### (Polycarbonate Type Resin Film)

Various kinds of polycarbonate type resin are used for produce the polycarbonate resin film, and aromatic polycarbonate is preferable and bisphenol A type polycarbonate is particularly preferable from the viewpoint of chemical and physical properties. Among them, ones using a bisphenol A derivative in which a benzene ring, cyclohexane ring or an aliphatic hydrocarbon group is introduced are more preferable, particularly, polycarbonate reduced in the anisotropy of the unit molecule obtained by using a bisphenol A derivative in which the above group is asymmetrically introduced onto the central carbon atom is preferable. For instance, a polycarbonate obtained by using bisphenol A in which the two methyl groups on the central carbon atom are substituted by a benzene ring or that in which one hydrogen atom of each of the benzene rings is asymmetrically substituted by a group such as a methyl group or a phenyl group as to the central carbon atoms is preferable.

In concrete, the above compound is one obtained from a 4,4′-hydroxydiphenylalkane or a halogen substituted derivative thereof by phosgene method or ester exchanging method such as 4,4′-dihydroxydiphenylmethane, 4,4′ dihydroxy diphenylethane and 4,4′-dihydroxydiphenylbutane.

The retardation film composed of the polycarbonate may be mixed with another transparent resin such as polystyrene type resin, methylmethacrylate type resin and cellulose ester type resin, and the polycarbonate resin may be laminated on at least on side of cellulose ester type film. The production method of the polycarbonate type film preferably to be used in the embodiment of the invention is not specifically limited. Namely, the film may be produced by an extrusion method, a solvent cast method or a calender method. In the embodiment of the invention, the polycarbonate type film satisfying the designated retardation values of the in-face and the thickness directions and reduced in the distortion can be obtained by applying any of mono-axial stretching and biaxial stretching and the production method including the stretching process relating to the invention the same as that described as to the cellulose ester film.

The polycarbonate type film having a glass transition point Tg of not less than 110° C. and a moisture absorbing ratio measured by immersing in water for 24 hours at 23° C. of not more than 0.3% is preferably used in the embodiment of the invention. One having the Tg is not less than 120° C. and the moisture absorbing ratio of not more than 0.2% is more preferably used.

### (Polyester Type Resin Film)

The polyester constituting the polyester type resin film to be preferably used in the embodiment of the invention is a film formable polyester having a dicarboxylic acid component and a diol component as principal constituting components though the polyester is not specifically limited.

As the important dicarboxylic acid component, terephthalic acid, isophthalic acid, phthalic acid, 2,6-naphthalenedicarboxylic acid, 2,7-naphthalenedicarboxylic acid, diphenylsulfondicarboxylic acid, diphenyletherdicarboxylic acid, diphenylethanedicarboxylic acid, cyclohexanedicarboxylic acid, diphenylicetone-dicarboxylic acid and phenylindanedicarboxylic acid can be cited. As the diol component, ethylene glycol, propylene glycol, tetramethylene glycol, cyclohexanedimethanol, 2,2-bis(4-hydroxyphenyl)propane, 2,2-bis(4-hydroxyethoxy-phenyl)propane, bis(4-hydroxyphenyl)sulfone, bisphenol-fluorenedihydroxyethyl ether, diethylene glycol, neopentyl glycol and cyclohexanonediol can be cited.

Among the polyesters having the above components as the principal constituting components, polyester principally constituted terephthalic acid and/or 2,6-naphthalenedicarboxylic acid as the dicarboxylic acid component and ethylene glycol and/or 1.4-cyclohexanedimethanol as the diol component are preferable from the viewpoint of transparency, mechanical strength and dimensional stability. Among them, polyester mainly constituted by poly(ethylene terephthalate) or poly(ethylene-2,6-naphthalate), a copolymerized polyester composed of terephthalic acid, 2,6-naphthalenedicarboxylic acid and ethylene glycol and a polyester mainly constituted by a mixture of two kinds of the above polyesters are preferred.

The polyester constituting the polyester type resin film to be used in the embodiment of the invention may be copolymerized with another copolymerizable component or mixed with another kind of polyester within the range in which the effects of the invention is not impeded. As such the components, the foregoing dicarboxylic acid components and diol components can be applied.

A bisphenol type compound and a compound having a naphthalene ring or cyclohexane ring can be copolymerized for raising the thermal resistivity of the film. The copolymerization ratio of such the compound is preferably from 1 to 20 mole-% of the reactive dicarboxylic acid constituting the polyester.

The film production method of the polyester type resin film preferably used in the embodiment of the invention is the melt-extrusion film forming method. The polyester type film satisfying the designated retardation values of the in-face and the thickness directions and reduced in the distortion can be obtained by applying any of mono-axial stretching and biaxial stretching and the production method including the stretching process relating to the invention the same as that described as to the cellulose ester film.

### (Polylactic Acid Type Rein Film)

### (Polylactic Acid Resin)

The polylactic acid resin preferably used for the support of the retardation film relating to the invention includes polylactic acid, a copolymer of lactic acid and a copolymerizable polyfunctional compound such as a hydroxycarboxylic acid, a copolymer of lactic acid, a polyol and a polyvalent carboxylic acid, and a mixture of them. Among the lactic acid polymers, homopolymer of lactic acid particularly L-polylactic acid is more preferable.

In the case of the mixture, a compatibilizer may be contained. When the polylactic acid type resin is the copolymer, arrangement of the copolymer may be any of a random copolymer, an alternative copolymer, a block copolymer and a graft copolymer. They may be ones at least partially crosslinked by a crosslinking agent, for example, a polyvalent isocyanate such as xylylenediisocyanate and 2,4-tolylenediisocyanate or a polysaccharide such as cellulose, acetyl cellulose and ethyl cellulose, and at least partially having any of a linear, cyclic, branched, star-shaped and three dimensional net work structure without any limitation.

### (Lactic Acid)

As lactic acid to be used as the raw material of the polylactic acid resin, L-lactic acid, D-lactic acid, DL-lactic acid, and a mixture of them are cited. When a lactide, namely a cyclic dimer of lactic acid, is used as the raw material of the resin, L-lactide, D-lactide, meso-lactide and a mixture of them are applicable.

A copolymer of lactic acid and a (co)polymerizable poly-functional compound other than lactic acid having desired optical purity can be obtained by variously combining such the optical isomers or by the reaction condition, and the contents of the isomer is preferably from 0 to 10%, more preferably from 0 to 5%, and preferably from 0 to 2%, by weight. For example, when the lactic acid is L-lactic acid, the content of D-lactic acid is preferably from 0 to 10%, more preferably from 0 to 5%, and further preferably from 0 to 2%, by weight.

### (Copolymerizable Poly-Functional Compound)

Examples of the copolymerizable compound include a hydroxycarboxylic acid such as glycolic acid, dimethylglycolic acid, 2-hydroxybutylic acid, 3-hydroxybutylic acid, 4-hydroxybutylic acid, 2-hydroxypropionic acid, 3-hydroxypropionic acid, 2-hydroxyvaleic acid, 3-hydroxyvaleric acid, 4-hydroxyvaleric acid, 5-hydroxyvaleric acid, 2-hydroxycapronic acid, 3-hydroxycapronic acid, 4-hydroxycapronic acid, 5-hydroxycapronic acid, 6-hydroxycapronic acid, 6-hydroxymethylcapronic acid and mandelic acid; a cyclic ester such as glycolide, β-metyl-δ-valerolactone, γ-valerolactone and ε-caprolactone; a polyvalent carboxylic acid and an anhydride thereof such as oxalic acid, malonic acid, succinic acid, glutalic acid, adipic acid, pimelic acid, azelaic acid, sebacic acid, undecanoic acid, dodecanoic acid and terephthalic acid; a polyol such as ethylene glycol, diethylene glycol, triethylene glycol, 1,2-propanediol, 1,3-propanediol, 1,3-butanediol, 1,4-butanediol, 3-methyl-1,5-pentanediol, 2,3-butanediol, 1,5-pentanediol, 1,6-hexanediol, 1,9-nonanediol, neopentyl glycol, tetramethylene glycol and 1,4-hexanedimethanol; a polysaccharose such as cellulose; and an aminocarboxylic acid such as α-amino acid. These copolymerizable poly-functional compounds are used solely or in a mixture, and the compound may be a mixture in optional ratio of L-form, D-form when the compound has an asymmetry carbon.

### (Production Method of Polylactic Acid Type Resin)

The polylactic acid type resin to be used in the embodiment of the invention can be produced for instance by the method described in Tokkai Sho 59-96123 and Tokkai Hei 7-33861 in which lactic acid is directly dehydrated and condensed, and the method described in U.S. Pat. No. 4,057,357 and Polymer Bulletin, 14, pp. 491-495 (1985), Makromol. Chem. 187, pp. 1611-1628 (1986) in which the lactide, cyclic dimer of lactic acid, is polymerized by ring-opening. The polymerization can be performed by using the functional group on the support as the initiator.

The weight average molecular weight Mw of the polylactic acid resin to be used in the embodiment of the invention is preferably from 10,000 to 10,000,000, more preferably from 30,000 to 3,000,000, and further preferably from 50,000 to 100,000 though the molecular weight is not specifically limited. The weight average molecular weight Mw and the molecular weight distribution (Mw/Mn) can be controlled to desired values by suitably selecting the reaction conditions such as kind of the raw material, kind of the solvent, kind and amount of the catalyst, reaction temperature and dehydration degree of the reaction system.

In the embodiment of the invention, a UV absorbent, a plasticizer or a fine particle is preferably added into the polylactic acid resin.

The formation method of the polylactic acid type rein film preferably usable in the embodiment of the invention is the melt-extrusion film forming method. The polylactic acid type film satisfying the designated retardation values of the in-face and the thickness directions and reduced in the distortion can be obtained by applying any of mono-axial stretching and biaxial stretching and the production method including the stretching process relating to the invention the same as that described as to the cellulose ester film.

### (Polarizing Plate)

The polarizing plate can be produced by usual method. It is preferable that the backside of the retardation film of the invention is subjected to a hydrophilizing treatment such as a plasma treatment or alkali saponifying treatment and pasted on at least one side of the polarizing membrane which is prepared by immersing and stretching in an iodine solution using an aqueous solution of completely saponified poly(vinyl alcohol). On the other side, the film or another polarizing plate protection film may be used. For such the film, a cellulose ester film available on the market such as Konica Minolta TAC KC8UX, KC4UX, KC8UXX, KC8UCR3, KC8UCR4, KC8UY, KC4UY, KCl₂UR, KC8UCR-3, KC8UCR-4, KC8UCR-5, KCOBY-HA, KC8UX-RHA and KC8UX-RHA-N each manufactured by KONICA MINOLTA OPTO INC. is preferably used.

The polarization membrane as the principal constitution element of the polarizing plate is a element capable of permeating light polarized in a designated direction and the known typical polarization membrane is a poly(vinyl alcohol) type polarization film which includes a poly(vinyl alcohol) type film dyed by iodine and that dyed by a dichromic dye. As the polarization membrane, one prepared by forming film from an aqueous solution of poly(vinyl alcohol) and then the film is mono-axially stretched and dyed or dyed and mono-axially stretched and preferably subjected to durability providing treatment by a boron compound is used. The optical film of the invention is pasted on the surface of the polarization membrane to prepare a polarizing plate. The pasting is preferably carried out by using an aqueous type adhesive principally composed of completely saponified polyvinyl alcohol).

### (Display)

A liquid crystal display can be produced by building-in the polarizing plate to a liquid crystal displaying apparatus. The optical film relating to the invention is preferably applied for a reflection type, transmission type or semi-transmission type LCD or various diving type LCD such as a TN type, STN type, OCB type, HAN type, VA (PVA and MVA) type, and IPS type.

### EXAMPLES

The invention is described in detail bellow referring examples; but the invention is not limited to them.

### Example 1

### Measurement of Glass Transition Temperature Tg of Film

Ten milligram of film sample was heated from −40° C. to 200° C. at a temperature raising rate of 20° C./minute using a DSC instrument DSC220, manufactured by Seiko Instruments Inc., for obtaining an endothermic curve. Tangent lines were drawn after and before the inflection point of thus obtained endothermic curve and the crossing point of them is defined as the glass transition temperature Tg.

### <Film Temperature>

In the frying apparatus shown in FIG. 2, three non-contact type surface thermometers, Infrared Thermometer IT 2-80, manufactured by Keyence Corp., were arranged in the width direction of the film and the surface temperature of film was measured and the average of the measured values was defined as the temperature of the film.

### <<Preparation of Retardation Film>>

### (Preparation of Cellulose Ester Film)

### (Materials to be Used)

### <Cellulose Ester>

C-1. Cellulose acetate propionate: Acetyl group

substitution degree=1.9, propionyl group substitution

degree=0.7, molecular weight Mn=70,000, molecular

weight Mw=200,000 and Mw/Mn=2.9

### <Plasticizer>

| | | |
|---|---|---|
| P-1. Trimethylpropane tribenzoate | 15 | parts by weight |

<Antioxidant>

| | | |
|---|---|---|
| S-1. Irganox 1010 | 0.5 | parts by weight |
| (Ciba Specialty Chemicals Inc.) | | |
| S-2. GSYP101 | 0.25 | parts by weight |
| (Sakai Chemical Industry Co., Ltd.) | | |
| S-3. Sumilizer GS | 0.24 | parts by weight |
| (Sumitomo Chemical Co., Ltd.) | | |

<UV absorbent>

| | | |
|---|---|---|
| V-1. Sumisoap 250 | 2.9 | parts by weight |
| (Sumitomo Chemical Co., Ltd.) | | |

The above cellulose ester was thermally treated at 120° C. for 1 hour in dried air and cooled by room temperature by standing in the dried air. The above plasticizer P-1, and the additives or oxidants S-1, S-2 and S-3 and the UV absorbent V-1 were added to 100 parts by weight of the dried cellulose ester and mixed by a Henschel mixer and pelletized by using an extruder, and stood for cooling. The glass transition temperature Tg of the pellet after film formation was 143° C.

The pellets were dried at 120° C. and then melted at 230° C. by using the extruder in the equipment shown in FIG. 1 and filtered through the filter and formed by extruding through the die at a barrel temperature of 230° C. The extruded unstretched film was cooled through a taking up roller according to the temperature condition (temperature, keeping time and temperature hysteresis pattern) shown in Table 1 and then heated by using the heating apparatus shown in FIGS. 2(a) to 2(d) After that, the film was cooled and stretched in the width direction for 1.2 times by the tenter and then alleviated and both edges were cut off by slitting while cooling. After cooled by room temperature (20° C.), the film was provided with knurling at the both edge portions and winded up to obtain Retardation Film 1 described in Table 1 in a rolled state having a width of 1,500 mm and a thickness of 80 μm.

In Table 1, the temperature hysteresis patterns correspond to the cooling process (step A), the heating process (step B), and the stretching process (step C) in the temperature hysteresis graphs shown in FIGS. 3a to 3d. The film temperature described in Table 1 is a film temperature measured at the middle point of holding time in each of the processes by the foregoing non-contacting type surface thermometer.

Cellulose ester resin type Retardation Films 2 to 14 were prepared in the same manner as above except that the temperature conditions (temperature, time and temperature hysteresis pattern) were varied as described in Table 1.

### (Preparation of Cycloolefin Type Resin Film)

A cycloolefin type thermoplastic norbornene resin (commercial name of Zeonoa #1600 manufactured by Zeon Corp.) having a number average molecular weight of about 20,000 and a Tg of 161° C. was used as the material and cycloolefin resin type Retardation Films 15 and 16 having a thickness of 80 μm were prepared in the same manner as in the above cellulose ester type resin film except that the temperature conditions (temperature, time and temperature hysteresis pattern) were varied as described in Table 1.

### <<Evaluation>>

Thus obtained Retardation Films 1 to 16 were evaluated as follows.

### (Measurement of Retardation Ro and Rt)

The average refractive index of each of the films was measured by using an Abbe's refractometer (4T) and the thickness of each of the films was measured by a micrometer available on the market.

The films were stood for 24 hours under a condition of 23° C. and 55% RH and retardation of each of the films was measured at a wavelength of 590 nm by an automatic double refractometer KOBRA-21ADH, manufactured by Oji Scientific Instrument, under the same condition. The in-plane retardation Ro and the thickness direction retardation Rt were obtained by substituting the following expressions by above obtained refractive index and the thickness. Thus obtained results are listed in Table 1.

Ro=(nx−ny)×d Equation 1

Rt={(nx+ny)/2−nz}×d Equation 2

In the above expressions, nx is an in-plane refractive index in a slow axis direction of the film, ny is an in-plane refractive index in a fast axis direction of the film, nz is the refractive index in the thickness direction of the film and d is the thickness (nm) of the film.

Thereafter, polarizing plates were prepared each using the above prepared Retardation Films 1 to 16 in the following procedure and subjected to evaluation.

### <<Preparation of Polarizing Plate>>

Polarizing plates were prepared using Retardation Films 1 to 16.

Poly(vinyl alcohol) film having a thickness of 120 μm was mono-axially stretched at a stretching ratio of 5 times at a temperature of 110° C. The stretched film was immersed for 60 seconds in an aqueous solution composed of 0.075 g of iodine, 5 g of potassium iodide and 100 g of water and then immersed in an aqueous solution composed of 6 g of potassium iodide, 7.5 g of boric acid ant 100 g of water at 68° C. Then the film was washed and dried to obtain a polarization membrane.

Polarizing plates were prepared by laminating the polarization membrane, each of the foregoing Retardation Films 1 to 19 and Konica Minolta TAC KC8UX-RHA, manufactured by KONICA MINOLTA OPTO INC., as the cellulose ester film for backside according to the following processes 1 to 5.

Process 1: The cellulose ester film was immersed in an aqueous 1 mole/L sodium hydroxide solution for 60 seconds at 50° C., and washed and dried to prepare the film saponified on the side to be pasted with the polarization membrane.

Process 2: The polarization membrane was immersed in a poly(vinyl alcohol) adhesive having a solid content of 2% by weight for 1 to 2 seconds.

Process 3: The adhesive excessively adhering on the polarization membrane in Process 2 was lightly wiped off and the membrane was placed on the cellulose ester film treated in Process 1 and KC8UX-RHA was further placed so that the anti-reflection layer of it is to be outside.

Process 4: The retardation film, the polarization membrane and the cellulose ester film piled in Process 3 were pasted at a pressure of 20 to 30 N/cm² and a transfer rate of about 2 m/minute.

Process 5: The samples prepared by pasting the polarization membrane, the cellulose ester film and each of the Retardation Films 1 to 16 in Process 4 were dried 2 for minutes to prepare Polarizing Plates 1 to 16, respectively.

### <<Preparation of Liquid Crystal Display>>

From a liquid crystal TV available on the market, Aquos 32AD5 manufactured by Sharp Corp., the polarizing plate was peeled and each of the above prepared Polarizing Plates 1 to 16 was pasted onto the glass face of the liquid crystal cell.

On this occasion, the direction of the pasting of the polarizing plate was set so that the surface of the retardation film was faced to the liquid crystal cell and The direction of the absorption axis of the polarizing plate is agreed with that of the previously pasted polarizing plate. Thus Displays 1 to 16 were prepared.

### <<Evaluation>>

### (Evaluation of Front-View Contrast)

The measurement was carried out under an environment of 23° C. and 55% RH and at 30 minutes after lighting and standing the backlight of the liquid crystal TV. The luminance of white image and black image displayed on the liquid crystal TV was measured by EZ-Contrast 160D, manufactured by ELDIM, in the direction of normal line of the displaying face and the ratio of them was defined as the front-view contrast. The higher ratio corresponds to excellence in the contrast.

Front-view contrast=(Luminance of the white image measured from the normal line direction of the display)/(Luminance of the black screen measured from the normal line direction of the display)

The results of the above evaluations are listed in Table 1.

TABLE 1

| | Kind of | Glass | | | | | Holding | | | | |
|---|---|---|---|---|---|---|---|---|---|---|---|
| Retar- | thermo- | transition | Thermal | | | | time in | | | | |
| dation | plastic | temperature | hysteresis | Film temperature (° C.) | | | Step B | Ro | Rt | | Re- |
| film | resin film | Tg (° C.) | pattern | Step A | Step B | Step C | (sec.) | (nm) | (nm) | Contrast | marks |
| 1 | *1 | 143 | FIG. 3(a) | 90 | 165 | 140 | 30 | 35 | 145 | 750 | Inv. |
| 2 | *1 | 143 | FIG. 3(a) | 90 | 175 | 140 | 30 | 35 | 145 | 720 | Inv. |
| 3 | *1 | 143 | FIG. 3(a) | 90 | 195 | 140 | 30 | 35 | 145 | 720 | Inv. |
| 4 | *1 | 143 | FIG. 3(a) | 90 | 225 | 140 | 30 | 30 | 150 | 510 | Comp. |
| 5 | *1 | 143 | FIG. 3(c) | 90 | — | 90 | — | 50 | 80 | 500 | Comp. |
| 6 | *1 | 143 | FIG. 3(a) | 40 | 175 | 150 | 30 | 35 | 145 | 720 | Inv. |
| 7 | *1 | 143 | FIG. 3(a) | 70 | 175 | 150 | 35 | 40 | 150 | 730 | Inv. |
| 8 | *1 | 143 | Fig. 3(a) | 150 | 190 | 150 | 30 | 30 | 140 | 720 | Inv. |
| 9 | *1 | 143 | FIG. 3(c) | 165 | — | 165 | 30 | 36 | 270 | 560 | Comp. |
| 10 | *1 | 143 | FIG. 3(a) | 90 | 146 | 130 | 30 | 40 | 150 | 700 | Inv. |
| 11 | *1 | 143 | FIG. 3(a) | 90 | 146 | 115 | 30 | 40 | 140 | 520 | Comp. |
| 12 | *1 | 143 | FIG. 3(a) | 90 | 156 | 136 | 30 | 35 | 135 | 720 | Inv. |
| 13 | *1 | 143 | FIG. 3(a) | 90 | 175 | 150 | 30 | 35 | 135 | 730 | Inv. |
| 14 | *1 | 143 | FIG. 3(a) | 90 | 146 | 205 | 30 | 10 | 110 | 530 | Comp. |
| 15 | Cycloolefin | 161 | FIG. 3(a) | 80 | 175 | 165 | 30 | 40 | 150 | 750 | Inv. |
| | type resin | | | | | | | | | | |
| 16 | Cycloolefin | 161 | FIG. 3(d) | 80 | 140 | 130 | 30 | 38 | 165 | 550 | Comp. |
| | type resin | | | | | | | | | | |

*1: Cellulose ester type resin, Inv.: Inventive, Comp.: Comparative

The contrast of the displays using the comparative retardation films are within the range of from 500 to 600. Contrary to that, the contrast of liquid crystal Displays 1 to 3, 6 to 8, 10, 12, 13 and 15 was 700 or more. Thus it was understood that the contrast was considerably improved.

### Example 2

Retardation Films 17 to 27 were prepared in the same manner as in Example 1 except that the holding time in Step B was varied and the luminance was measured from the normal line direction in the same manner as in Example 1 for evaluating the front-view contrast.

The results of the evaluations are listed in Table 2.

TABLE 2

| | Kind of | Glass | | | | | Holding | | | | |
|---|---|---|---|---|---|---|---|---|---|---|---|
| Retar- | thermo- | transition | Thermal | | | | time in | | | | |
| dation | plastic | temperature | hysteresis | Film temperature (° C.) | | | Step B | Ro | Rt | | Re- |
| film | resin film | Tg (° C.) | pattern | Step A | Step B | Step C | (sec.) | (nm) | (nm) | Contrast | marks |
| 17 | *1 | 143 | FIG. 3(a) | 90 | 165 | 140 | 1 | 35 | 145 | 700 | Inv. |
| 18 | *1 | 143 | FIG. 3(a) | 90 | 165 | 140 | 10 | 35 | 145 | 750 | Inv. |
| 19 | *1 | 143 | FIG. 3(a) | 90 | 165 | 140 | 20 | 35 | 145 | 750 | Inv. |
| 20 | *1 | 143 | FIG. 3(a) | 90 | 165 | 140 | 40 | 35 | 145 | 750 | Inv. |
| 21 | *1 | 143 | FIG. 3(a) | 90 | 165 | 140 | 50 | 35 | 145 | 750 | Inv. |
| 22 | *1 | 143 | FIG. 3(a) | 90 | 165 | 140 | 100 | 35 | 145 | 750 | Inv. |
| 23 | *1 | 143 | FIG. 3(a) | 90 | 165 | 140 | 300 | 30 | 160 | 700 | Inv. |
| 24 | *1 | 143 | FIG. 3(b) | 90 | 165 | 140 | 40 | 30 | 140 | 680 | Inv. |
| 25 | *1 | 143 | FIG. 3(b) | 90 | 165 | 140 | 30 | 35 | 145 | 680 | Inv. |
| 26 | *1 | 143 | FIG. 3(d) | 90 | 130 | 135 | 20 | 35 | 110 | 520 | Comp. |
| 27 | *1 | 143 | FIG. 3(d) | 90 | 130 | 135 | 40 | 35 | 115 | 530 | Comp. |

*1: Cellulose ester type resin, Inv.: Inventive, Comp.: Comparative

In the case of Retardation Films 17 to 25 with the holding time in Step B of from 1 to 300 seconds, the contrast of the displays each using the retardation films was not less than 680. Therefore, it is understood that the contrast is improved. In the case of displays using comparative example Retardation Films 26 and 27 in which the heating temperature is lower than the glass transition temperature Tg, the contrast was within the range of from 500 to 600, even when the holding time in Step B takes from 1 to 300 seconds.

### Example 3

Retardation film were prepared in the same manner as Examples 1 and 2 except that the tenter stretching apparatus was changed to that capable of independently varying the holding length (the distance from the beginning position to the end position of the holding) on right and left side, respectively, and the front-view contrast of the displays using thus obtained retardation films were determined by measuring the luminance from the normal line direction of the displaying face in the same manner as in Examples 1 and 2. It was understood that the retardation films of the invention improve the front-view contrast in the same or more degree compared with the retardation film of the invention obtained in Examples 1 and 2.

### INDUSTRY APPLICABILITY

The invention can provide a retardation film improved in the light leaking through the polarizing plate, the dimensional stability under a high temperature and high humidity and the front-view contrast of the liquid crystal, a production method of the retardation film, a polarizing plate and a liquid crystal display.

1. A method of producing a retardation film, comprising:
extruding a composition comprising a thermoplastic resin and having a temperature To (° C.) through a die;
cooling step of cooling a film having a glass transition temperature Tg (° C.) and extruded through the die, to a temperature Ta (° C.);
at least once raising a temperature of the film which is cooled, to a temperature Tb (° C.); and
cooling the film which is heated, to a temperature Tc (° C.) and stretching the film which is cooled in a width direction of the film,
wherein the temperature Ta satisfies Ta<To and Ta<(Tg+10)° C.,
the temperature Tb satisfies Tb>Ta and Tg≦Tb≦(Tg+70)° C., and
the temperature Tc satisfies Tc<Tb and (Tg−20)° C.≦Tc≦(Tg+50)° C.

2. The method of claim 1,
wherein the composition comprises a plasticizer or an antioxidant.

3. The method of claim 1,
wherein, the film is held at the temperature Tb (° C.) in the heating step for not less than 1 second and not larger than 300 seconds.

4. The method of claim 1,
wherein the thermoplastic resin is selected form the group consisting of a cellulose type resin, a cycloolefin type resin, a polycarbonate type resin, a polyester type resin and a polylactic acid type resin.

5. The method of claim 4,
wherein a major component of the cellulose type resin is a cellulose ester which is at least one selected from the group consisting of cellulose acetate, cellulose propionate, cellulose butylate, cellulose acetate propionate, cellulose acetate butylate, cellulose acetate phthalate and cellulose phthalate.

6. The method of claim 1,
wherein the temperature To (° C.) satisfies (Tg+50)° C.≦To≦(Tg+140)° C.

7. The method of claim 1,
wherein the temperature Tb (° C.) satisfies Tb>Ta and Tg≦Tb≦(Tg+55)° C.

8. A retardation film produced by the method of claim 1.

9. The retardation film of claim 8,
wherein the retardation film comprises a slow axis in a width direction of the film,
an in-plane retardation value Ro is in a range of 30 to 100 nm,
a retardation value Rt in a thickness direction of the film is in a range of 70 to 300 nm, and
a ratio of Rt/Ro is from 2 to 5,
where Ro=(nx−ny)×d,
Rt={(nx+ny)/2−nz}×d,
nx is an in-plane refractive index in a slow axis direction of the film,
ny is an in-plane refractive index in a fast axis direction of the film,
nz is a refractive index in the thickness direction of the film, and
d is a thickness (nm) of the film.

10. A polarizing plate comprising:
a polarizing element; and
the retardation film of claim 8 pasted on at least one surface of the polarizing element.

11. A liquid crystal display comprising the polarizing plate of claim 10.
